(19) United States
(12) Patent Application Publication
(10) Pub. No.: US 2012/0275399 A1
(43) Pub. Date: Nov. 1, 2012

(54) SYSTEM AND METHOD FOR SYNCHRONIZED RADIO LINK CONTROL AND MEDIA ACCESS CONTROL IN A WIRELESS COMMUNICATION NETWORK

(75) Inventors: Zhengwei Liu, San Diego, CA (US); Arnaud Meylan, San Diego, CA (US); Xiaoxia Zhang, San Diego, CA (US); Kuo-Chun Lee, San Diego, CA (US)

(73) Assignee: QUALCOMM INCORPORATED, San Diego, CA (US)

(21) Appl. No.: 13/456,124

(22) Filed: Apr. 25, 2012

Related U.S. Application Data
(60) Provisional application No. 61/479,802, filed on Apr. 27, 2011.
(60) Provisional application No. 61/529,781, filed on Aug. 31, 2011.

(51) Int. Cl. H04W 72/04

(52) U.S. Cl. 370/329

(57) ABSTRACT

Techniques are provided for synchronized radio link control (RLC) and/or media access control (MAC). For example, there is provided a method that involves generating an RLC protocol data unit (PDU) according to a segmentation protocol for maximizing RLC PDU size while allowing the RLC PDU to fit into a defined MAC transport block, the RLC PDU comprising at least one RLC service data unit (SDU) or RLC SDU segment. The method may involve determining a PDU data size for each given RLC SDU. The method may further involve (a) attaching a given RLC SDU to the RLC PDU and (b) delivering the RLC PDU to a lower layer, in response to a SDU data size for the given RLC SDU exceeding a defined size limit.

### CROSS-REFERENCE TO RELATED APPLICATIONS

The present application for patent claims priority to Provisional Application No. 61/479,802, filed Apr. 27, 2011, entitled “SYSTEM AND METHOD FOR RADIO LINK CONTROL IN A WIRELESS COMMUNICATION SYSTEM”, and to Provisional Application No. 61/529,781, filed Aug. 31, 2011, entitled “SYSTEM AND METHOD FOR SYNCHRONIZED RADIO LINK CONTROL AND MEDIA ACCESS CONTROL IN A WIRELESS COMMUNICATION NETWORK”, both of which are assigned to the assignee hereof, and are hereby expressly incorporated in their entirety by reference herein.

### BACKGROUND

1. Field

Aspects of the present disclosure relate generally to wireless communication systems, and more particularly, to Radio Link Control (RLC) segmentation.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of network entities, such as base stations, that can support communication for a number of mobile entities/devices, such as, for example, user equipments (UEs) or access terminals (ATs). A mobile entity may communicate with a base station via a downlink and uplink. The downlink (or forward link) refers to the communication link from the base station to the UE, and the uplink (or reverse link) refers to the communication link from the UE to the base station.

The 3rd Generation Partnership Project (3GPP) Long Term Evolution (LTE) represents a major advance in cellular technology as an evolution of Global System for Mobile communications (GSM) and Universal Mobile Telecommunications System (UMTS). The LTE physical layer (PHY) provides a way to convey both data and control information between a base station, such as an evolved Node B (eNB), and a mobile entity, such as a UE, with increased efficiency and throughput.

In the context of LTE, information may be delivered among network entities and mobile entities as media access control (MAC) protocol data units (PDUs) and radio link control (RLC) PDUs, wherein a given RLC PDU may include at least one RLC service data unit (SDU) or RLC SDU segment. In unicast, the maximum RLC SDU size is specified in a Packet Data Convergence Protocol (PDCP). Since the PDCP is not applicable to Multimedia Broadcast Multicast Service (MBMS), there remains a need to specify a maximum RLC SDU size. Accordingly, described herein are techniques to address issues associated with RLC the segmentation process.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more aspects of the embodiments described herein, there is provided a method for synchronized radio link control (RLC) operable by a network entity (e.g., an eNB or the like). The method may involve generating an RLC protocol data unit (PDU) according to a segmentation protocol for maximizing RLC PDU size while allowing the RLC PDU to fit into a defined media access control (MAC) transport block, the RLC PDU comprising at least one RLC service data unit (SDU) or RLC SDU segment. The method may further involve determining a PDU data size for each given RLC SDU. The method may also involve (a) attaching a given RLC SDU to the RLC PDU and (b) delivering the RLC PDU to a lower layer, in response to a SDU data size for the given RLC SDU exceeding a defined size limit. In related aspects, an electronic device (e.g., an eNB or component(s) thereof) may be configured to execute the above-described methodology.

In accordance with one or more aspects of the embodiments described herein, a method is provided for MAC operable by a network entity (e.g., an eNB or the like). The method may involve determining that the network entity is participating in a broadcast service. The method may involve generating a MAC PDU according to a segmentation protocol for maximizing RLC PDU size to maximize a number of RLC PDUs multiplexed from a given logical channel, the protocol being synchronized across a group of network entities participating in the broadcast service. In related aspects, an electronic device (e.g., an eNB or component(s) thereof) may be configured to execute the above-described methodology.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a downlink frame structure in a telecommunications system.

FIG. 3 is a block diagram conceptually illustrating a design of a base station/eNB and a UE configured according to one aspect of the present disclosure.

FIG. 4 is a diagram of a signaling frame illustrating an example of symbol allocation for unicast and multicast signals.

FIG. 5 is a diagram illustrating MBMS over a Single Frequency Network (MBSFN) areas within an MBSFN service area.

FIG. 6 is a block diagram illustrating components of a wireless communication system for providing or supporting MBSFN service.

FIG. 7A shows a MAC PDU.

FIGS. 7B-D show examples of MAC subheaders.

FIG. 8A provides a table with sample LCID values.

FIG. 8B provides a table for interpreting a Format (F) field of a MAC PDU.

FIG. 9 illustrates a sample MSI MAC control element.

FIGS. 10A-B provide TBS lookup tables.

FIG. 11 shows an RLC PDU structure.

FIG. 12 shows a UMD RLC header having one RLC SDU.

FIG. 13 shows a UMD RLC header having multiple RLC SDUs.

FIG. 14 provides a table for interpretation of the FI field of the RLC header.

FIG. 15A provides a table for interpretation of the E field of the RLC header (for E field in the fixed part of the header).

FIG. 15B provides a table for interpretation of the E field of the RLC header (for E field in the extension part of the header).

FIG. 16 shows a technique for using multiple RLC PDUs per MTC.

FIG. 17 illustrates an embodiment of an RLC methodology performed at a network entity.

FIG. 18 illustrates an embodiment of an apparatus for RLC, in accordance with the methodology of FIG. 17.

FIGS. 19-20 show techniques for LI scaling.

FIG. 21 illustrates another embodiment of an RLC methodology performed at a network entity.

FIG. 22 illustrates an embodiment of an apparatus for RLC, in accordance with the methodology of FIG. 21.

FIG. 23 shows a technique for using a new RLC header format.

FIG. 24 illustrates another embodiment of an RLC methodology performed at a network entity.

FIG. 25 illustrates an embodiment of an apparatus for RLC, in accordance with the methodology of FIG. 24.

FIG. 26 illustrates another embodiment of an RLC methodology performed at a network entity.

FIG. 27 illustrates an embodiment of an apparatus for RLC, in accordance with the methodology of FIG. 26.

FIG. 28 illustrates another embodiment of an RLC methodology performed at a network entity.

FIG. 29 illustrates an embodiment of an apparatus for RLC, in accordance with the methodology of FIG. 28.

FIG. 30 illustrates another embodiment of an RLC methodology performed at a network entity.

FIG. 31 illustrates an embodiment of an apparatus for RLC, in accordance with the methodology of FIG. 30.

FIG. 32 illustrates another embodiment of an RLC methodology performed at a network entity.

FIG. 33 illustrates an embodiment of an apparatus for RLC, in accordance with the methodology of FIG. 32.

FIG. 34 illustrates another embodiment of an RLC methodology performed at a network entity.

FIG. 35 illustrates an embodiment of an apparatus for RLC, in accordance with the methodology of FIG. 34.

FIG. 36 shows a first technique for RLC/MAC synchronization.

FIG. 37 shows a second technique for RLC/MAC synchronization.

FIG. 38 shows an embodiment of a methodology for synchronized RLC operation by a network entity (e.g., an eNB or the like).

FIG. 39 shows an embodiment of an apparatus for synchronized RLC operation, in accordance with the methodology of FIG. 38.

FIG. 40 shows an embodiment of a methodology for synchronized MAC operation by a network entity (e.g., an eNB or the like).

FIG. 41 shows an embodiment of an apparatus for synchronized MAC operation, in accordance with the methodology of FIG. 40.

FIG. 42 shows another embodiment of a methodology for synchronized MAC operation by a network entity (e.g., an eNB or the like).

FIG. 43 shows an embodiment of an apparatus for synchronized MAC operation, in accordance with the methodology of FIG. 42.

### DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As used herein, the term exemplary refers to an embodiment that serves an example or illustration of a given concept, and does not necessarily refer to a best mode or a preferred mode.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

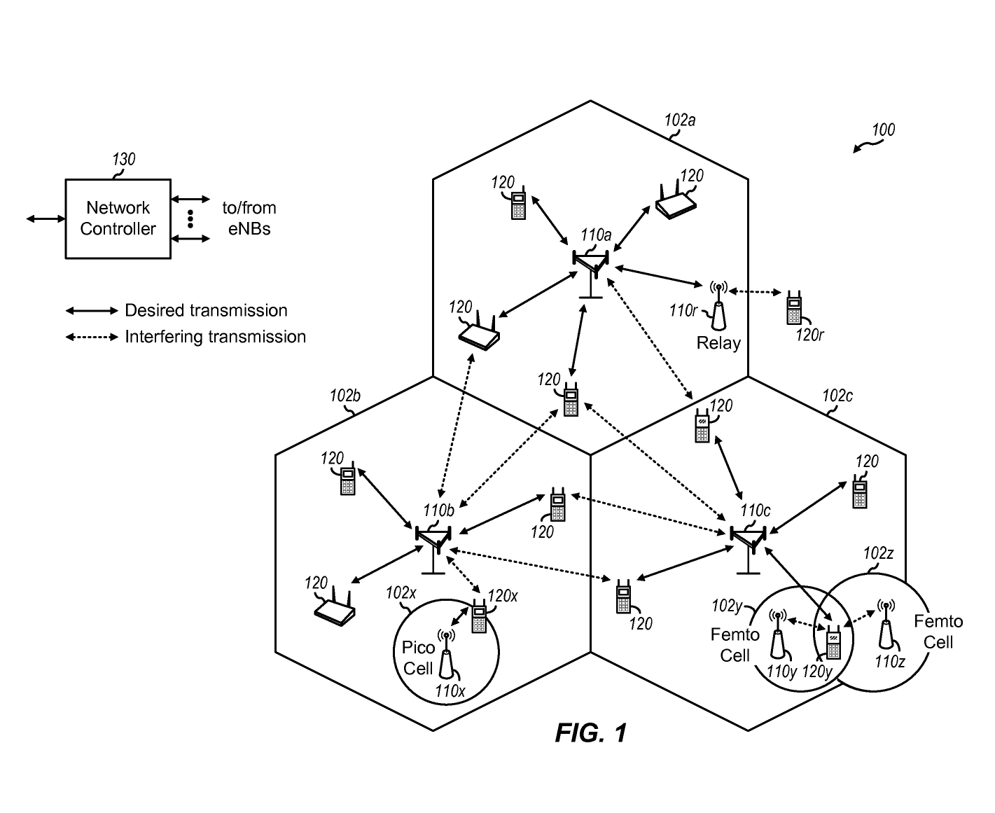

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

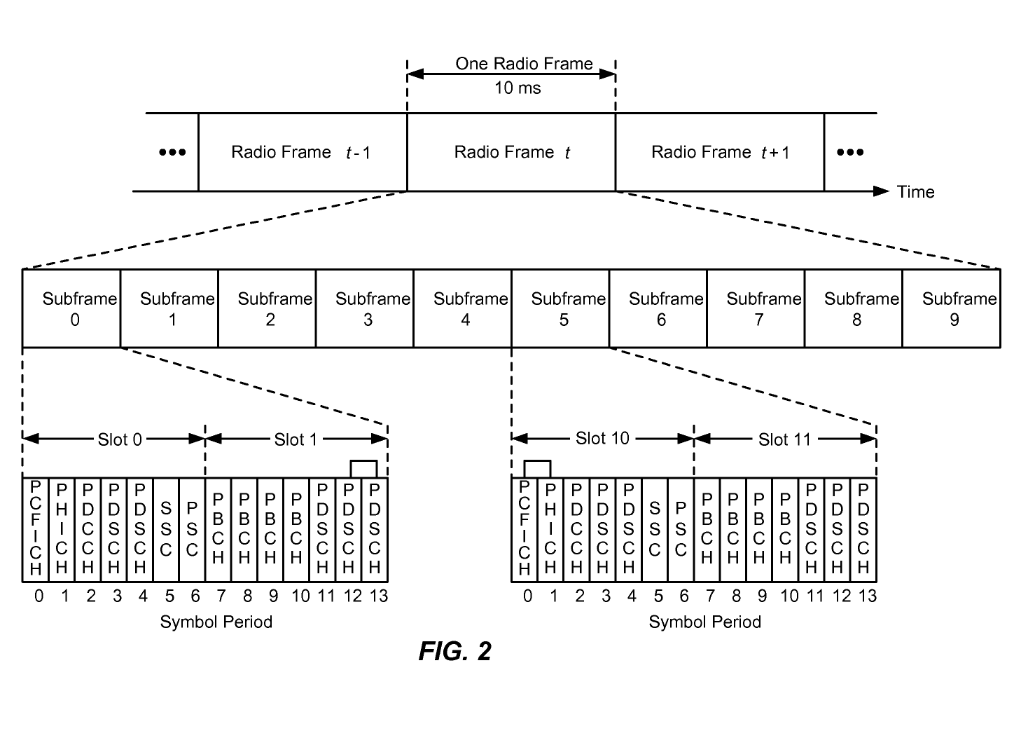

FIG. 2 shows an exemplary down link frame structure that may be used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

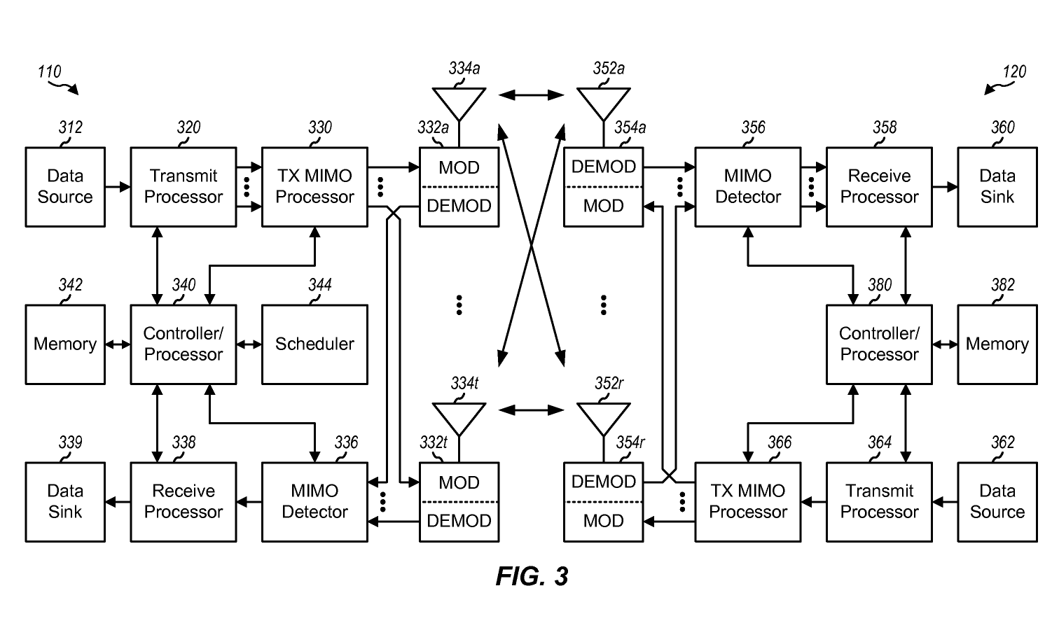

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODS) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

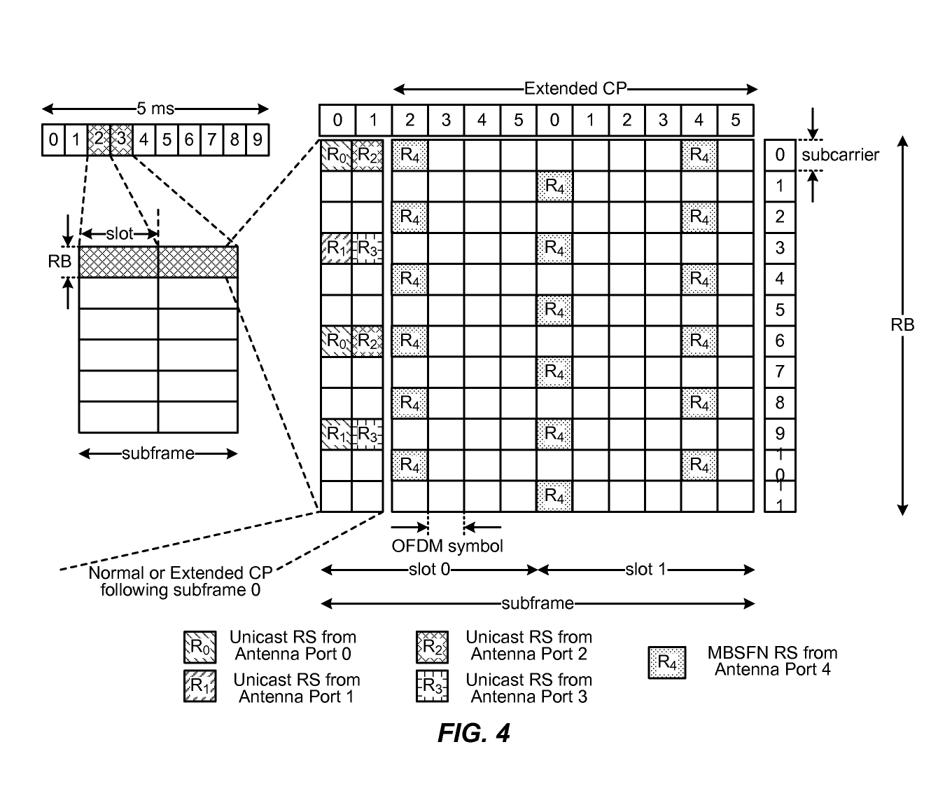

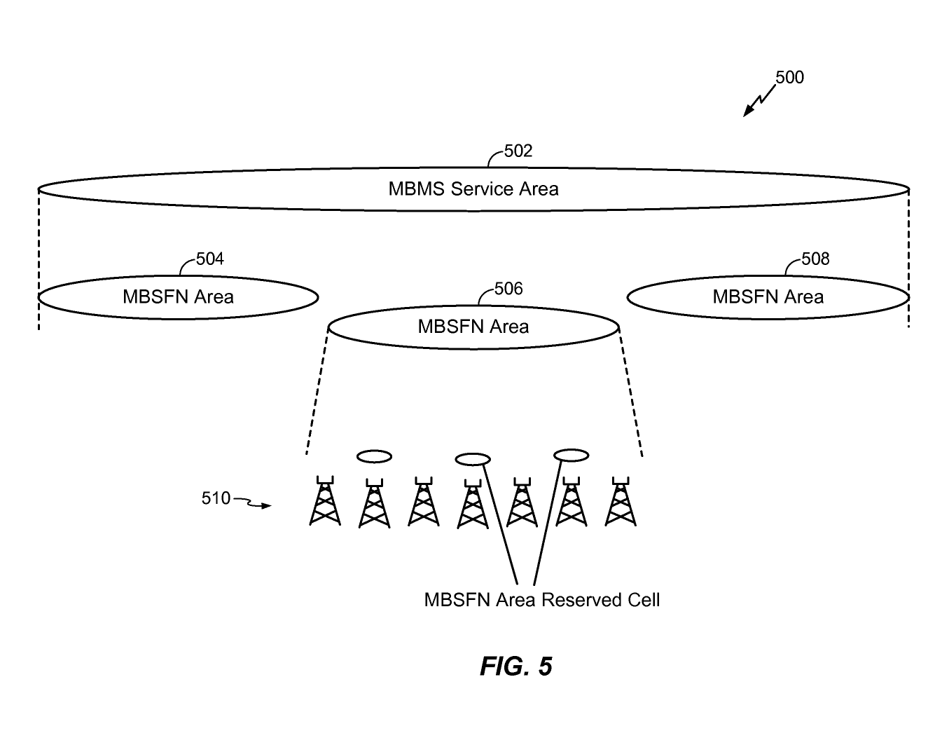

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

eMBMS and UNICAST SIGNALING IN SINGLE FREQUENCY NETWORKS: One mechanism to facilitate high bandwidth communication for multimedia has been single frequency network (SFN) operation. Particularly, Multimedia Broadcast Multicast Service (MBMS) and MBMS for LTE, also known as evolved MBMS (eMBMS) (including, for example, what has recently come to be known as multimedia broadcast single frequency network (MBSFN) in the LTE context), can utilize such SFN operation. SFNs utilize radio transmitters, such as, for example, eNBs, to communicate with subscriber UEs. Groups of eNBs can transmit information in a synchronized manner, so that signals reinforce one another rather than interfere with each other. In the context of eMBMS, the shared content is transmitted from multiple eNB's of a LTE network to multiple UEs. Therefore, within a given eMBMS area, a UE may receive eMBMS signals from any eNB (or eNBs) within radio range. However, to decode the eMBMS signal each UE receives Multicast Control Channel (MCCH) information from a serving eNB over a non-eMBMS channel. MCCH information changes from time to time and notification of changes is provided through another non-eMBMS channel, the PDCCH. Therefore, to decode eMBMS signals within a particular eMBMS area, each UE is served MCCH and PDCCH signals by one of the eNBs in the area.

In accordance with aspects of the subject of this disclosure, there is provided a wireless network (e.g., a 3GPP network) having features relating to single carrier optimization for eMBMS. eMBMS provides an efficient way to transmit shared content from an LTE network to multiple mobile entities, such as, for example, UEs.

With respect a physical layer (PHY) of eMBMS for LTE Frequency Division Duplex (FDD), the channel structure may include time division multiplexing (TDM) resource partitioning between an eMBMS and unicast transmissions on mixed carriers, thereby allowing flexible and dynamic spectrum utilization. Currently, a subset of subframes (up to 60%), known as multimedia broadcast single frequency network (MBSFN) subframes, can be reserved for eMBMS transmission. As such current eMBMS design allows at most six out of ten subframes for eMBMS.

An example of subframe allocation for eMBMS is shown in FIG. 4, which shows an existing allocation of MBSFN reference signals on MBSFN subframes, for a single-carrier case. Components depicted in FIG. 4 correspond to those shown in FIG. 2, with FIG. 4 showing the individual subcarriers within each slot and resource block (RB). In 3GPP LTE, an RB spans 12 subcarriers over a slot duration of 0.5 ms, with each subcarrier having a bandwidth of 15 kHz together spanning 180 kHz per RB. Subframes may be allocated for unicast or eMBMS; for example in a sequence of subframes labeled 0, 1, 2, 3, 4, 5, 6, 7, 8, and 9, subframes 0, 4, 5, and 9 may be excluded from eMBMS in FDD. Also, subframes 0, 1, 5, and 6 may be excluded from eMBMS in time division duplex (TDD). More specifically, subframes 0, 4, 5, and 9 may be used for PSS/SSS/PBCH/paging/system information blocks (SIBS) and unicast service. Remaining subframes in the sequence, e.g., subframes 1, 2, 3, 6, 7, and 8 may be configured as eMBMS subframes.

With continued reference to FIG. 4, within each eMBMS subframe, the first 1 or 2 symbols may be used for unicast reference symbols (RSs) and control signaling. A CP length of the first 1 or 2 symbols may follow that of subframe 0. A transmission gap may occur between the first 1 or 2 symbols and the eMBMS symbols if the CP lengths are different. In related aspects, the overall eMBMS bandwidth utilization may be 42.5% considering RS overhead (e.g., 6 eMBMS subframes and 2 control symbols within each eMBMS subframe). Known techniques for providing MBSFN RSs and unicast RSs typically involve allocating the MBSFN RSs on MBSFN subframes (as shown in FIG. 4), and separately allocating unicast RSs on non-MBSFN subframes. More specifically, as FIG. 4 shows, the extended CP of the MBSFN subframe includes MBSFN RSs but not unicast RSs. The present technology is not limited to the particular frame allocation scheme illustrated by FIGS. 2 and 4, which are presented by way of example, and not by way of limitation. A multicast session or multicast broadcast as used herein may use any suitable frame allocation scheme.

eMBMS SERVICE AREAS: FIG. 5 illustrates a system 500 including an MBMS service area 502 encompassing multiple MBSFN areas 504, 506, 508, which themselves include multiple cells or base stations 510. As used herein, an “MBMS service area” refers to a group of wireless transmission cells where a certain MBMS service is available. For example, a particular sports or other program may be broadcast by base stations within the MBMS service area at a particular time. The area where the particular program is broadcast defines the MBMS service area. The MBMS service area may be made up of one or more “MBSFN areas” as shown at 504, 506 and 508. As used herein, an MBSFN area refers to a group of cells (e.g., cells 510) currently broadcasting a particular program in a synchronized manner using an MBSFN protocol. An “MBSFN synchronization area” refers to a group of cells that are interconnected and configured in a way such that they are capable of operating in a synchronized manner to broadcast a particular program using an MBSFN protocol, regardless of whether or not they are currently doing so. Each eNB can belong to only one MBSFN synchronization area, on a given frequency layer. It is worth noting that an MBMS service area 502 may include one or more MBSFN synchronization areas (not shown). Conversely, an MBSFN synchronization area may include one or more MBSFN areas or MBMS service areas. Generally, an MBSFN area is made up of all, or a portion of, a single MBSFN synchronization area and is located within a single MBMS service area. Overlap between various MBSFN areas is supported, and a single eNB may belong to several different MBSFN areas. For example, up to 8 independent MCCHs may be configured in System Information Block (SIB) 13 to support membership in different MBSFN areas. An MBSFN Area Reserved Cell or Base Station is a cell/base station within a MBSFN Area that does not contribute to the MBSFN transmission, for example a cell near a MBSFN Synchronization Area boundary, or a cell that that is not needed for MBSFN transmission because of its location.

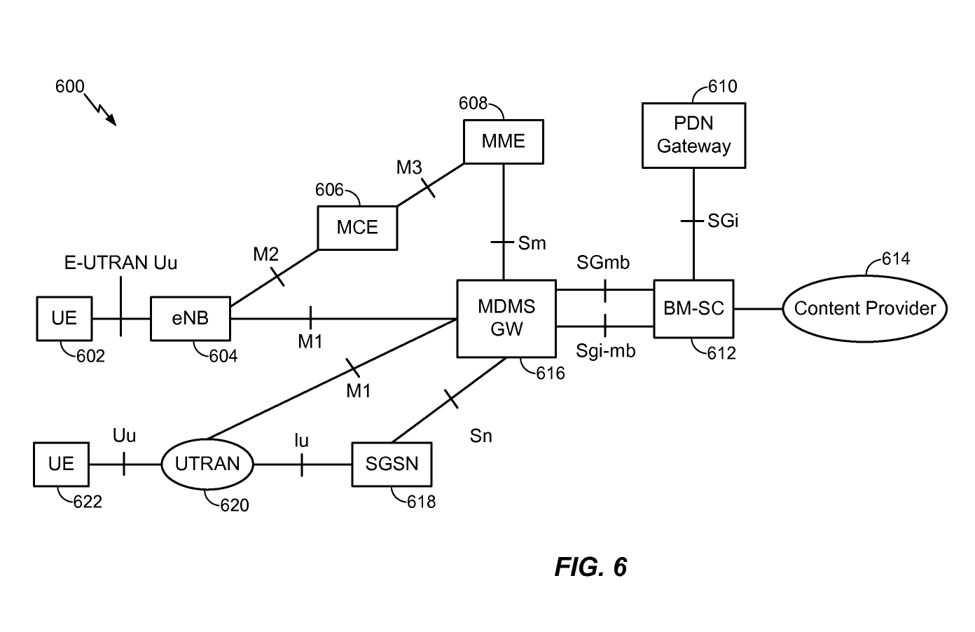

eMBMS SYSTEM COMPONENTS AND FUNCTIONS: FIG. 6 illustrates functional entities of a wireless communication system 600 for providing or supporting MBSFN service. Regarding Quality of Service (QoS), the system 600 may use a Guaranteed Bit Rate (GBR) type MBMS bearer, wherein the Maximum Bit Rate (MBR) equals the GBR. These components are shown and described by way of example, and do not limit the inventive concepts described herein, which may be adopted to other architectures and functional distributions for delivering and controlling multicast transmissions.

The system 600 may include an MBMS Gate Way (MBMS GW) 616. The MBMS GW 616 controls Internet Protocol (IP) multicast distribution of MBMS user plane data to eNBs 604 via an M1 interface; one eNB 604 of many possible eNBs is shown. In addition, the MBMS GW controls IP multicast distribution of MBMS user plane data to UTRAN Radio Network Controllers (RNCs) 620 via an M1 interface; one UTRAN RNC 620 of many possible RNCs is shown. The M1 interface is associated to MBMS data (user plane) and makes use of IP for delivery of data packets. The eNB 604 may provide MBMS content to a UE/mobile entity 602 via an E-UTRAN Uu interface. The RNC 620 may provide MBMS content to a UE mobile entity 622 via a Uu interface. The MBMS GW 616 may further perform MBMS Session Control Signaling, for example MBMS session start and session stop, via the Mobility Management Entity (MME) 608 and Sm interface. The MBMS GW 616 may further provide an interface for entities using MBMS bearers through the SG-mb (user plane) reference point, and provide an interface for entities using MBMS bearers through the SGi-mb (control plane) reference point. The SG-mb Interface carries MBMS bearer service specific signaling. The SGi-mb interface is a user plane interface for MBMS data delivery. MBMS data delivery may be performed by IP unicast transmission, which may be a default mode, or by IP multicasting. The MBMS GW 616 may provide a control plane function for MBMS over UTRAN via a Serving General Packet Radio Service Support Node (SGSN) 618 and the Sn/Iu interfaces.

The system 600 may further include a Multicast Coordinating Entity (MCE) 606. The MCE 606 may perform an admission control function form MBMS content, and allocate time and frequency radio resources used by all eNBs in the MBSFN area for multi-cell MBMS transmissions using MBSFN operation. The MCE 606 may determine a radio configuration for an MBSFN Area, such as, for example, the modulation and coding scheme. The MCE 606 may schedules and control user plane transmission of MBMS content, and manage eMBMS service multiplexing, by determining which services are to be multiplexed in which Multicast Channel (MCH). The MCE 606 may participate in MBMS Session Control Signaling with the MME 608 through an M3 interface, and may provide a control plane interface M2 with the eNB 604.

The system 600 may further include a Broadcast-Multicast Service Center (BM-SC) 612 in communication with a content provider server 614. The BM-SC 616 may handle intake of multicast content from one or more sources such as the content provider 614, and provide other higher-level management functions as described below. These functions may include, for example, a membership function, including authorization and initiation of MBMS services for an identified UE. The BM-SC 616 may further perform MBMS session and transmission functions, scheduling of live broadcasts, and delivery, including MBMS and associated delivery functions. The BM-SC 616 may further provide service advertisement and description, such as advertising content available for multicast. A separate Packet Data Protocol (PDP) context may be used to carry control messages between UE and BM-SC. The BM-SC may further provide security functions such as key management, manage charging of content providers according to parameters such as data volume and QoS, provide content synchronization for MBMS in UTRAN and in E-UTRAN for broadcast mode, and provide header compression for MBSFN data in UTRAN. The BM-SC 612 may indicate session start, update and stop to the MBMS-GW 616 including session attributes such as QoS and MBMS service area.

The system 600 may further include a Multicast Management Entity (MME) 608 in communication with the MCE 606 and MBMS-GW 608. The MME 600 may provide a control plane function for MBMS over E-UTRAN. In addition, the MME may provide the eNB 604, 620 with multicast related information defined by the MBMS-GW 616. An Sm interface between the MME 608 and the MBMS-GW 616 may be used to carry MBMS control signaling, for example, session start and stop signals.

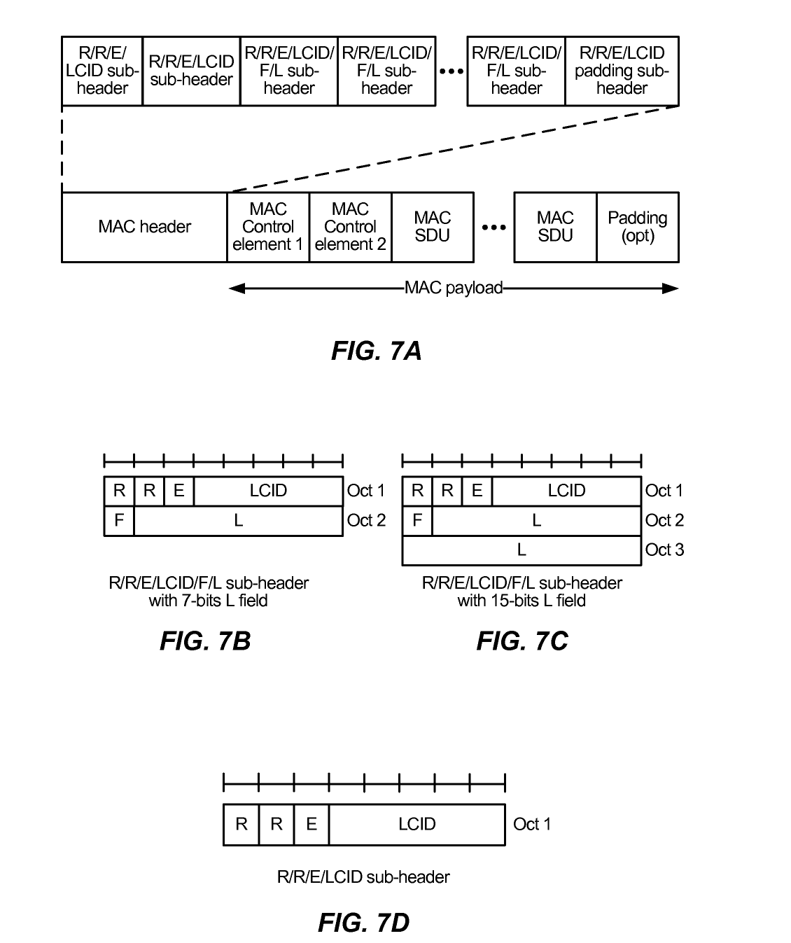

In accordance with aspects of the subject of this disclosure, a media access control (MAC) protocol data unit (PDU) may include a MAC header and a MAC payload, as shown in FIG. 7A. There may be a one-to-one mapping between the MAC sub-header to ControlElement/MAC service data unit (SDU)/Padding. With reference to FIGS. 7B-C, there are shown examples of R/R/E/LCID/F/L (six fields) MAC subheaders, wherein LCID means Logical Channel ID. An R/R/E/LCID/F/L subheader with a 7 bits L field is shown in FIG. 7B. An R/R/E/LCID/F/L subheader with a 15 bits L field is shown in FIG. 7C. With reference to FIG. 7D, there is shown an example of an R/R/E/LCID (four fields) MAC subheader.

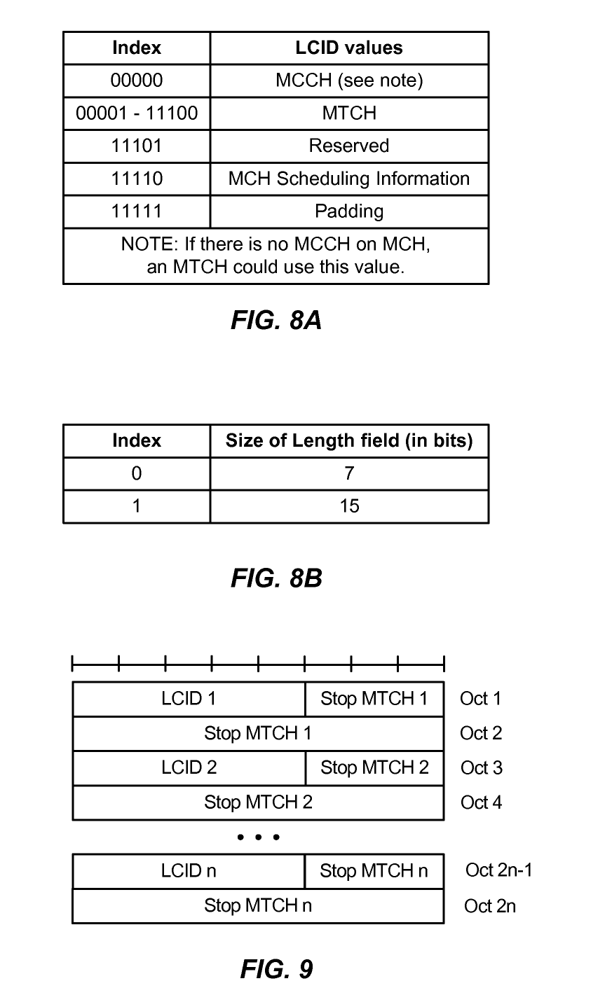

The MAC header may be of variable size and may include one or more of the following fields. The LCID field identifies the logical channel instance of the corresponding MAC SDU or the type of the corresponding MAC control element or padding, as shown in FIG. 8A. There may be one LCID field for each MAC SDU, MAC control element or padding included in the MAC PDU. For example, the LCID field size may be 5 bits. The Length (L) field indicates the length of the corresponding MAC SDU or variable-sized MAC control element in bytes. There may be one L field per MAC PDU subheader except for the last subheader and subheaders corresponding to fixed-sized MAC control elements. The size of the L field may be indicated by the Format (F) field, as shown in FIG. 8B. The F field may indicate the size of the L field. There may be one F field per MAC PDU subheader except for the last subheader and subheaders corresponding to fixed-sized MAC control elements. For example, the size of the F field may be 1 bit. The Extension (E) field may be a flag indicating if more fields are present in the MAC header or not. The Reserved (R) bit, may be set to “0”.

The MCH Scheduling Information (MSI) MAC Control Element, illustrated in FIG. 9, may be identified by a MAC PDU subheader with LCID. This control element may have a variable size. For each MTCH, the LCID and the Stop MTCH fields may be included. The LCID field may indicate the Logical Channel ID of the MTCH. For example, the length of the field may be 5 bits. The Stop MTCH field may indicate the ordinal number of the subframe within the MCH scheduling period where the corresponding MTCH stops. For example, the length of the Stop MTCH field may be 11 bits. The special Stop MTCH value 2047 may indicate that the corresponding MTCH is not scheduled. The value range 2043 to 2046 may be reserved.

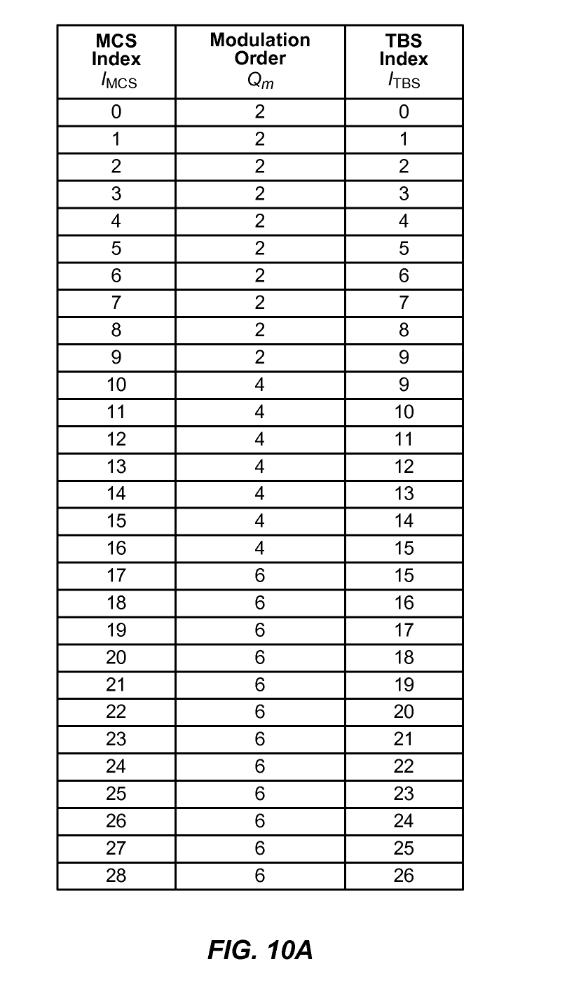

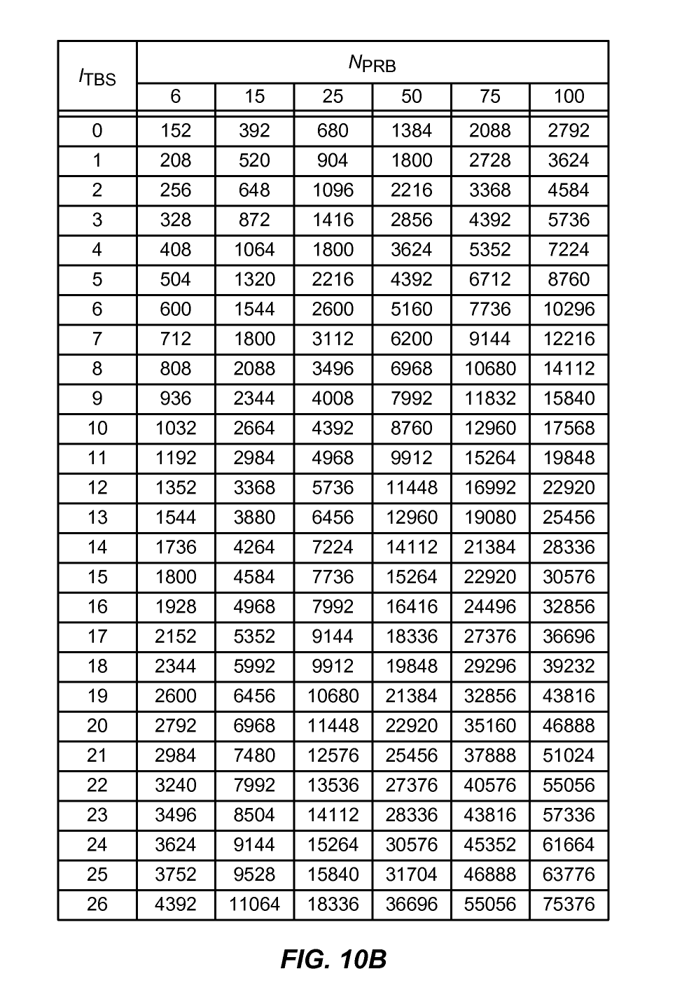

MAC PDU/MAC SDU/RLC PDU SIZE: For a 20 MHz DL band, the Max Transport Block (TB) size (i.e., MAC PDU size) may be 75376 bits, i.e., 9422 bytes. There may be only one MTCH scheduled per subframe. Since the MAC subheader size and eMBMS MAC control elements size are small, there may be a large radio link control (RLC) PDU with a size of around ˜9K bytes. In related aspects, examples of TB size (TBS) lookup tables are provided in FIGS. 10A-B.

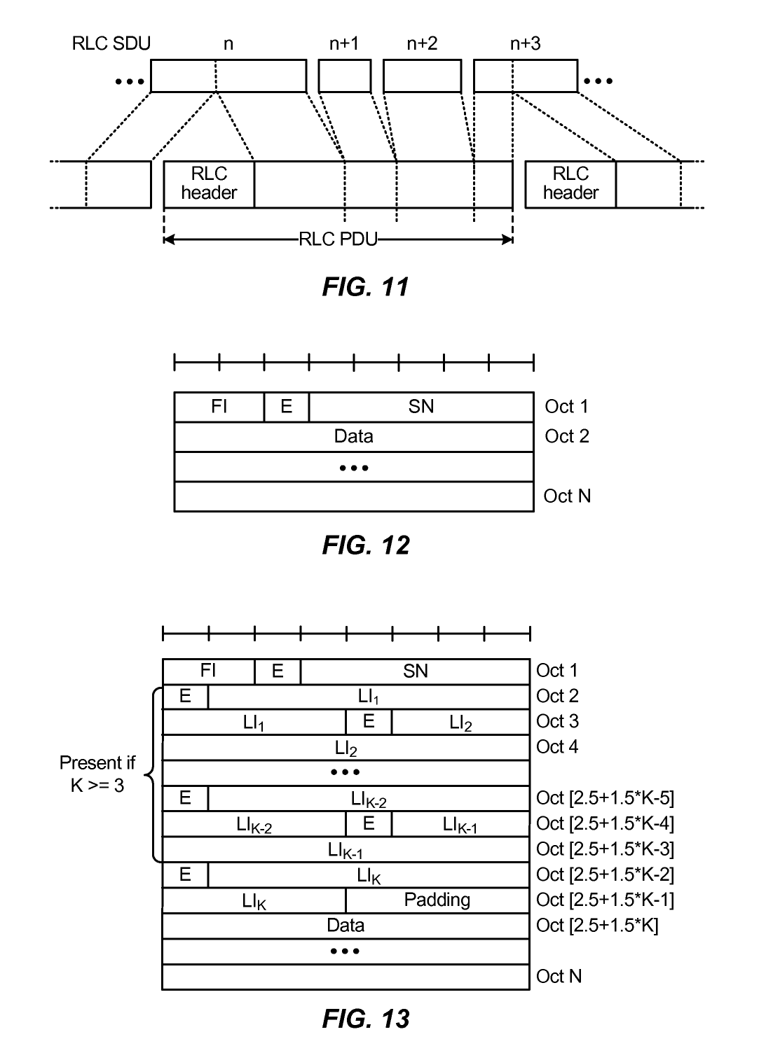

RLC: With reference to FIG. 11, there is shown an example RLC PDU structure, which includes at least one RLC SDU. In one embodiment, the unacknowledged mode data (UMD) RLC header (hdr) may contain one RLC SDU or SDU segment, as shown in FIG. 12. In another embodiment, the UMD RLC header (hdr) may contain more than one RLC SDU, as shown in FIG. 13. For example, the Length Indicator (LI) field indicates the length in bytes of the corresponding Data field element present in the RLC data PDU delivered/received by an unacknowledged mode (UM) or an acknowledged mode (AM) RLC entity.

The LI field is often limited to 11 bits. The first LI present in the RLC data PDU header may correspond to the first Data field element present in the Data field of the RLC data PDU, the second LI present in the RLC data PDU header may correspond to the second Data field element present in the Data field of the RLC data PDU, and so on. The remaining bits belong to the last RLC SDU or RLC SDU segment, so no LI is needed for the last RLC SDU or RLC SDU segment. The value 0 may be reserved.

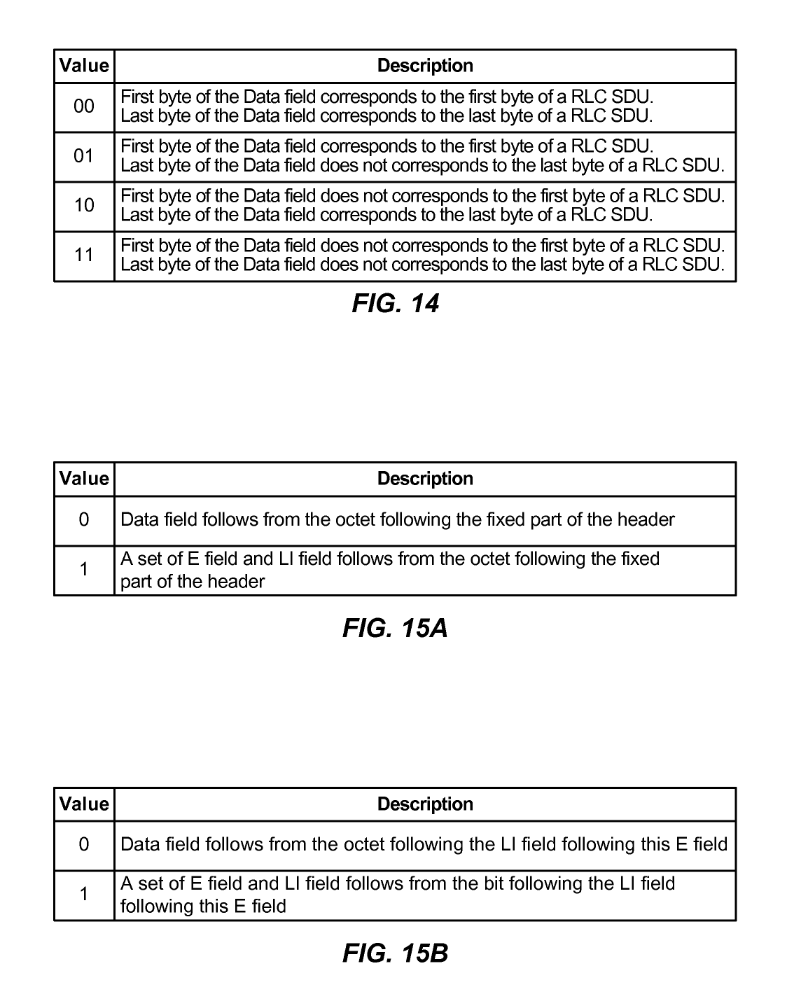

The FI field (e.g., 2 bits) indicates whether a RLC SDU is segmented at the beginning and/or at the end of the Data field. Specifically, the FI field may indicate whether the first byte of the Data field corresponds to the first byte of a RLC SDU, and whether the last byte of the Data field corresponds to the last byte of a RLC SDU. FIG. 14 provides an example table for interpretation of the FI field.

The E field (e.g., 1 bit) indicates whether a Data field or a set of E and LI fields follows the fixed part of the header. FIG. 15A provides an example table for interpretation of the E field (for E field in the fixed part of the header). FIG. 15B provides an example table for interpretation of the E field (for E field in the extension part of the header).

ISSUE ENCOUNTERED AT RLC SEGMENTATION PROCESS: For proper eMBMS operation, the eNBs in a MBSFN area transmitting the eMBMS signal should segment the packets in the same way. Otherwise, the eMBMS transmission could be different from the various eNBs, causing the received signals at the receiver to not appear as time delayed versions of each other. In unicast, the maximum RLC SDU size is specified in a Packet Data Convergence Protocol (PDCP). Since PDCP is not applicable to MBMS, there currently is no maximum RLC SDU size specified for MBMS. For example, the size of the LE field may be 11 bits. That allows the RLC to signal the end of an SDU as long as the size of the included segment is less than 2̂11 (=2048 bytes). Therefore, the RLC cannot concatenate an end of an SDU segment larger than 2048 bytes with any other subsequent SDU segment. Accordingly, a number of techniques are presented to address such issues associated with the RLC the segmentation process.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

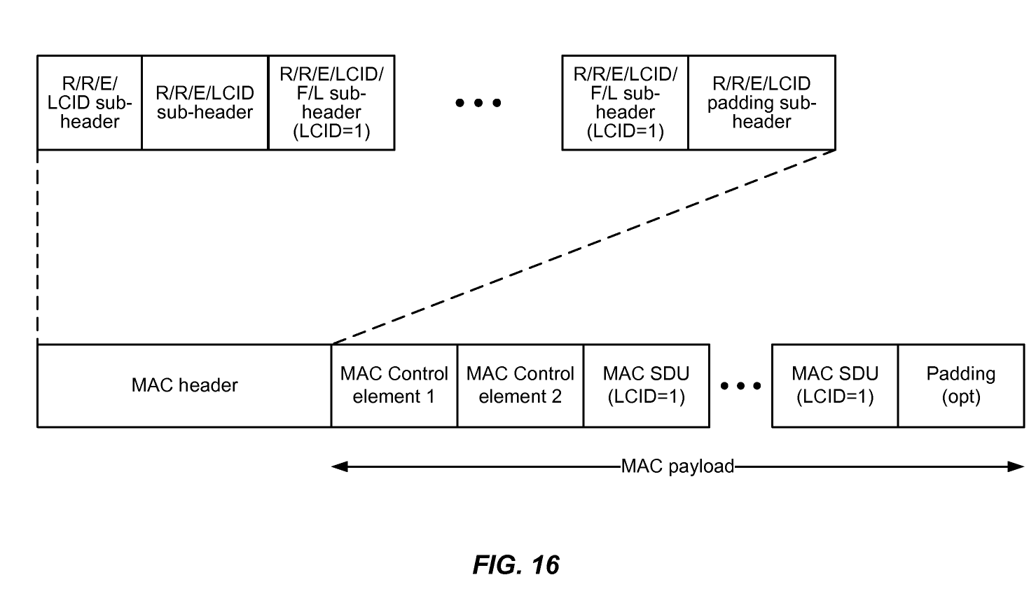

MULTIPLE MAC PDUs/SDUs: In accordance with one or more aspects of the embodiments described herein, there is provided a technique for using multiple RLC PDUs per MTCH, the technique being synchronized across multiple network entities (e.g., eNBs) in a given MBSFN area. For example, the technique may involve, for eMBMS, using multiple RLC PDUs per MTCH per subframe with each size, other than the last RLC PDU size, less than a defined size (e.g., 2K bytes), wherein the last RLC PDU may exceed the defined size. With reference to FIG. 16, for the same MTCH, the technique may involve splitting a large RLC PDU into several smaller RLC PDUs (i.e., split a large MAC SDU into several smaller MAC SDUs) with each RLC PDU (except for the last RLC PDU) having a size less than a defined size (e.g., 2K bytes) to fit a large MAC payload. All MAC SDU's LCID may be set to the same MTCH. In related aspects, a given chunk <2K in size is needed if the given chunk includes the end of the RLC SDU and the RLC desires to concatenate another SDU after that. The previous sentence holds because the last Data field does not have an LI field. As such, the RLC can include a given chunk >2K in size when the given chunk corresponds to the last Data field in the RLC PDU.

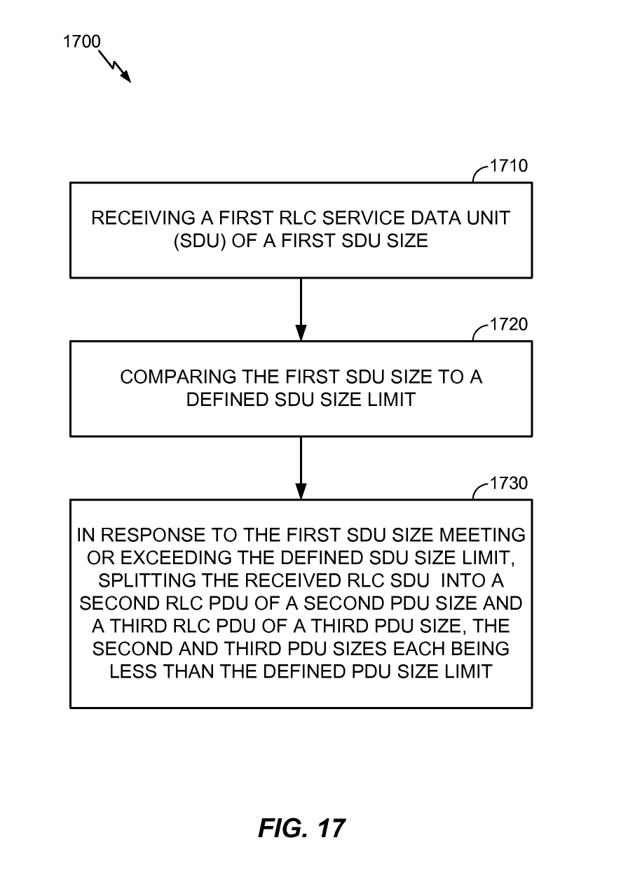

With reference to FIG. 17, illustrated is an RLC methodology 1700 for Multimedia Broadcast Multicast Service (MBMS) or the like that may be performed at a network entity, such as, for example, an eNB or the like. The method 1700 may involve receiving a first RLC service data unit (SDU) of a first SDU size (block 1710), and comparing the first SDU size to a defined SDU size limit (block 1720). The method 1700 involve, in response to the first SDU size meeting or exceeding the defined SDU size limit, splitting the received RLC SDU into a second RLC PDU of a second PDU size and a third RLC PDU of a third PDU size, the second and third PDU sizes each being less than the defined PDU size limit (block 1730).

In related aspects, each RLC SDU may be associated with a length indicator (LI) field that indicates a length in bytes of a corresponding data field element. For example, the indicated length in the LI field may be about 11 bits, the first SDU size of the first RLC SDU may be about 9K bytes, and the defined SDU size limit may be about 2K bytes.

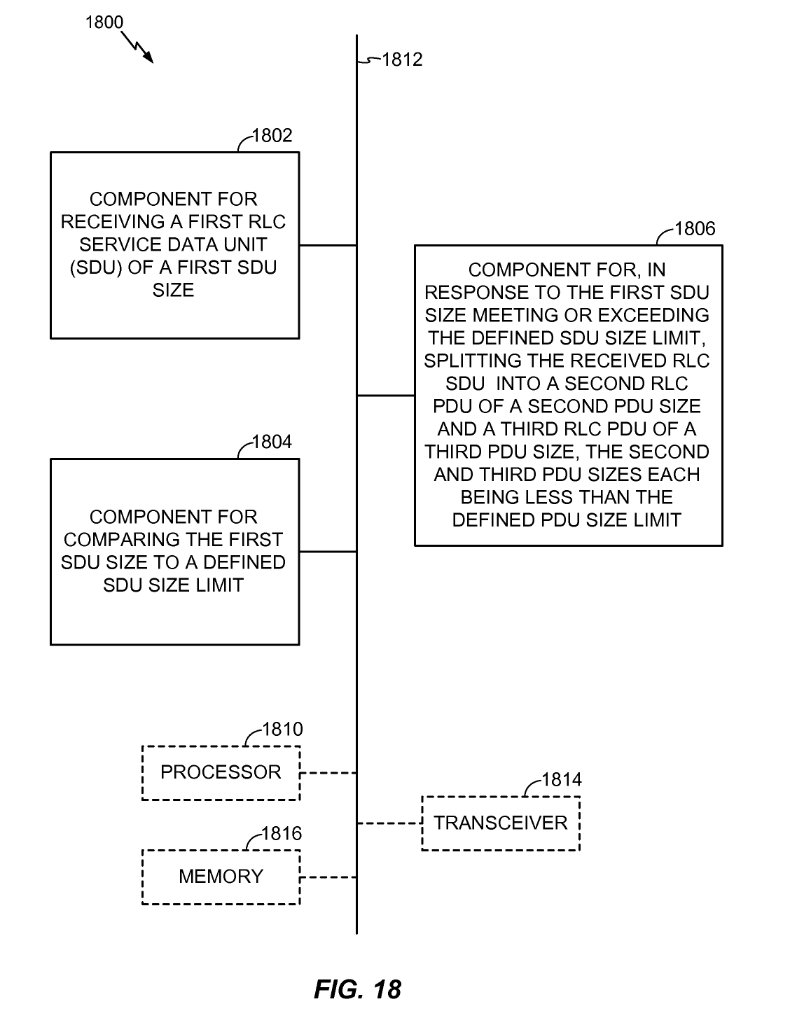

In accordance with one or more aspects of the embodiments described herein, there are provided devices and apparatuses for RLC, as described above with reference to FIG. 17. With reference to FIG. 18, there is provided an exemplary apparatus 1800 that may be configured as a network entity (e.g., eNB) in a wireless network, or as a processor or similar device for use within the network entity. The apparatus 1800 may include functional blocks that can represent functions implemented by a processor, software, or combination thereof (e.g., firmware).

As illustrated, in one embodiment, the apparatus 1800 may include an electrical component or module 1802 for receiving a first RLC service data unit of a first SDU size. For example, the electrical component 1802 may include a receiver coupled to a processor and/or a memory. The electrical component 1802 may be, or may include, a means for receiving a first RLC service data unit of a first SDU size. Said means may be or may include the at least one receiver (e.g., the MIMO detector 336 and/or receive processor 338 of FIG. 3).

The apparatus may include a component 1804 for comparing the first SDU size to a defined SDU size limit. For example, the electrical component 1804 may include at least one control processor coupled to a network interface or a receiver/transmitter and to a memory with instructions for coordinating MBMS or the like. The electrical component 1804 may be, or may include, a means for comparing the first SDU size to a defined SDU size limit Said means may be or may include the at least one control processor (e.g., the controller/processor 340 of FIG. 3) operating an algorithm. The algorithm may include determining whether the SDU size limit has been defined. The SDU size limit may be preconfigured. If the size limit has not already been preconfigured, the algorithm may include requesting the operator to define/configure the size limit or using a default size limit (e.g., 2K bytes) for the defined size limit. If the SDU size limit has been defined, the algorithm may include calculating the first SDU size or reading a field in the MAC header that indicates the first SDU size. The algorithm may include determining whether the first SDU size is greater than, equal to, or less than the defined size limit.

The apparatus may include a component 1806 for splitting the received RLC SDU into a second RLC PDU of a second PDU size and a third RLC PDU of a third PDU size, the second and third PDU sizes each being less than the defined PDU size limit, in response to the first SDU size meeting or exceeding the defined SDU size limit. It is noted that any SDU can be split. The eNB may decide how and when to split the SDU. For example, the electrical component 1806 may include at least one control processor coupled to a network interface or a receiver/transmitter and to a memory with instructions for coordinating MBMS or the like. The electrical component 1806 may be, or may include, a means for splitting the received RLC SDU into a second RLC PDU of a second PDU size and a third RLC PDU of a third PDU size. Said means may be or may include the at least one control processor (e.g., the controller/processor 340 of FIG. 3) operating an algorithm. The algorithm may include verifying that the first SDU size is greater than the SDU size limit. Upon verifying this, the algorithm may include calculating how to split the received RLC SDU into two separate RLC PDUs (i.e., the second and third RLC PDUs having the second and third PDU sizes, respectively), wherein the each of the separate RLC PDUs are smaller than the SDU size limit. The algorithm may include generating the two separate RLC PDUs from the received RLC SDU according to the previous calculation.

In related aspects, the apparatus 1800 may optionally include a processor component 1810 having at least one processor, in the case of the apparatus 1800 configured as a network entity, rather than as a processor. The processor 1810, in such case, may be in operative communication with the components 1802-1806 via a bus 1812 or similar communication coupling. The processor 1810 may effect initiation and scheduling of the processes or functions performed by electrical components 1802-1806.

In further related aspects, the apparatus 1800 may include a radio transceiver component 1818. A stand alone receiver and/or stand alone transmitter may be used in lieu of or in conjunction with the transceiver 1818. The apparatus 1800 may optionally include a component for storing information, such as, for example, a memory device/component 1816. The computer readable medium or the memory component 1816 may be operatively coupled to the other components of the apparatus 1800 via the bus 1812 or the like. The memory component 1816 may be adapted to store computer readable instructions and data for effecting the processes and behavior of the components 1802-1806, and subcomponents thereof, or the processor 1810, or the methods disclosed herein. The memory component 1816 may retain instructions for executing functions associated with the components 1802-1806. While shown as being external to the memory 1816, it is to be understood that the components 1802-1806 can exist within the memory 1816.

LI SCALING: In accordance with one or more aspects of the embodiments described herein, there is provided a technique for using an IP Packet header (hdr) length field as a length range indicator. PDCP specifies the maximum size of a PDCP SDU as 8188 octets; however, this size limitation is not applicable to eMBMS because transmissions on MTCH and MCCH do not use the PDCP. Hence, RLC SDUs are equivalent to IP packets. The IP header indicates the total length of an IP packet and could be used to trim bytes passed by the RLC layer, but which do not belong to the IP packet. In related aspects, this operation may be performed by the RLC layer.

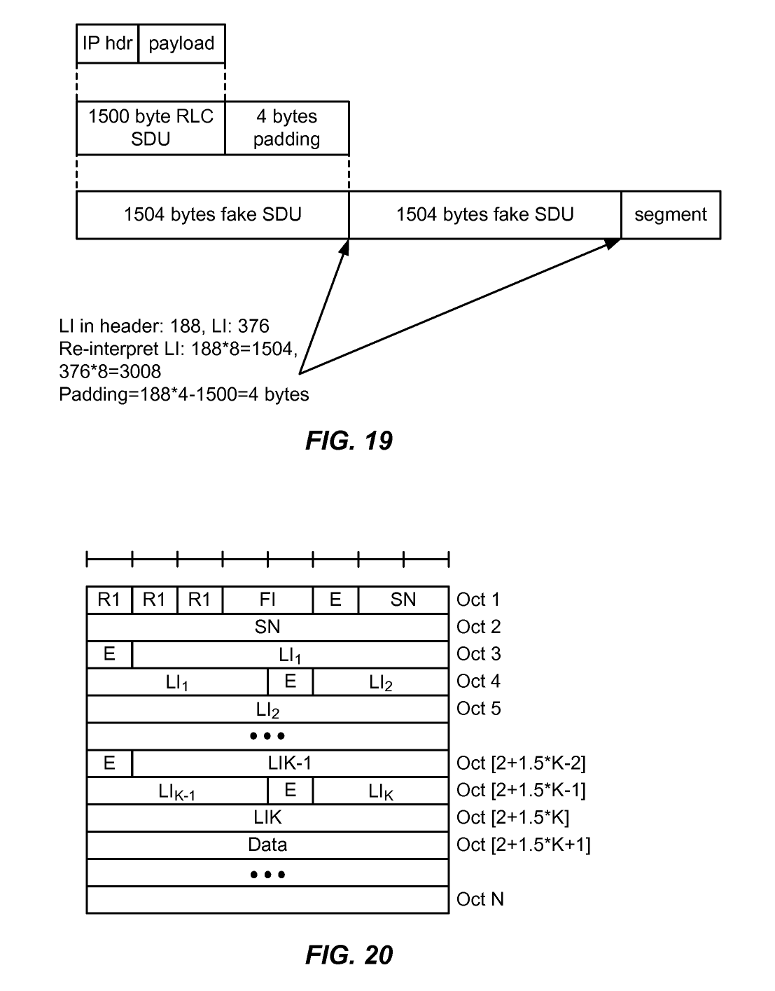

For example, the RLC UM MBMS receiver may re-interpret the LI field as: LI=8*LI when performing de-concatenation of a given RLC SDU (i.e., trimming down the given RLC SDU). The RLC UM MBMS receiver may peek into the IP total length header field (IP V4) or Payload length (IP v6) in order to trim the padding bits that do not belong to an IP packet before passing the RLC SDU(s) to upper layer. For example, LI may be scaled by a factor of 8, since 2k*8>9K bytes, as illustrated in FIG. 19.

In another embodiment, the LI field may be scaled by utilizing the 5 bit SN field as a common most significant bit (MSB) of the LIs. The LI fields may be scaled to (2**SN)*LI. Padding may be added if the RLC SDU size is not a multiple of 2**SN. For example, with reference to FIG. 13, if SN=4, LI1=2047, LI2=1024, then the real SDU size may be as follows: SDU1 size=2047*4 bytes; SDU2 size=1024*4 bytes; Padding1=SDU1 size−IPHdr1's IPTotalLen; and Padding2=SDU2 size−IPHdr2's IPTotalLen.

In yet another embodiment, a 10 bit SN header may be used instead of the 5 bit SN header. Since there are 3 R1 (1 bit reserved field) (R1 R1 R1), it can be used as a common MSB of the LIs. So the max SDU size can be 8 times larger than existing ones, thereby satisfying the eMBMS need to handle larger packets (16 KB>9 KB). An operation similar to the one in the previous paragraph may apply. For example, with reference to FIG. 20, if R1R1R1=100 (decimal value 4), LI1=2047, LI2=1024, then the real SDU size may be determined as follows: SDU1 size=2047*4 bytes; SDU2 size=1024*4 bytes; Padding1=SDU1 size−IPHdr1's IPTotalLen; and Padding2=SDU2 size−IPHdr2's IPTotalLen.

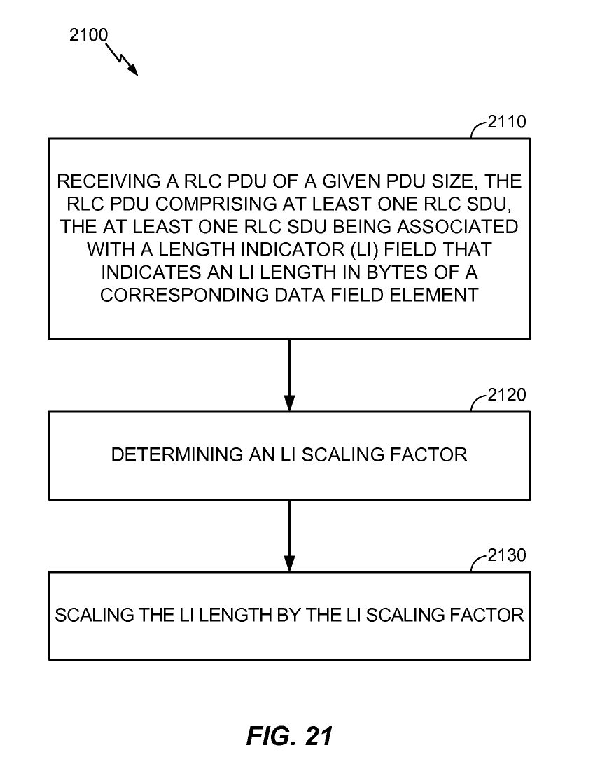

With reference to FIG. 21, illustrated is an RLC methodology 2100 for MBMS or the like that may be performed at a network entity, such as, for example, an eNB or the like. The method 2100 may involve: receiving a RLC PDU of a given PDU size, the RLC PDU comprising at least one RLC SDU, the at least one RLC SDU being associated with a length indicator (LI) field that indicates an LI length in bytes of a corresponding data field element (block 2110); determining an LI scaling factor (block 2120); and scaling the LI length by the LI scaling factor (block 2130).

In another embodiment, determining may involve calculating the LI scaling factor based at least in part on the given PDU size and a defined PDU size limit. In related aspects, an IP packet header of the at least one RLC SDU may indicate an IP packet length, and determining may involve calculating a padding based at least in part on the LI length, the LI scaling factor, and the IP packet length. In further related aspects, calculating the padding may involve determining the padding according to the following equation: (LI length)*(LI scaling factor)−(IP packet length). For example, the LI scaling factor may be a hard-coded value of 8. As shown in the example of FIG. 19, the padding may be equal to the LI length indicated in the header (e.g., 188 bytes) multiplied by the LI scaling factor (e.g., 8) minus the sum of the IP packet size (i.e., the IP header size plus the payload size) (e.g., 1500 bytes). As such, in the example of FIG. 18, the padding equals 4 bytes (i.e., 1504 bytes minutes 1500 bytes).

In yet another embodiment, determining may involve calculating the LI scaling factor based at least in part on a sequence number (SN) header of the RLC PDU. For example, the SN header may be 5 bits and/or the scaling factor may be 2**SN. In still another embodiment, the SN header may be 10 bits and 3 reserved bits, and the LI scaling factor may equal a value represented by the 3 reserved bits.

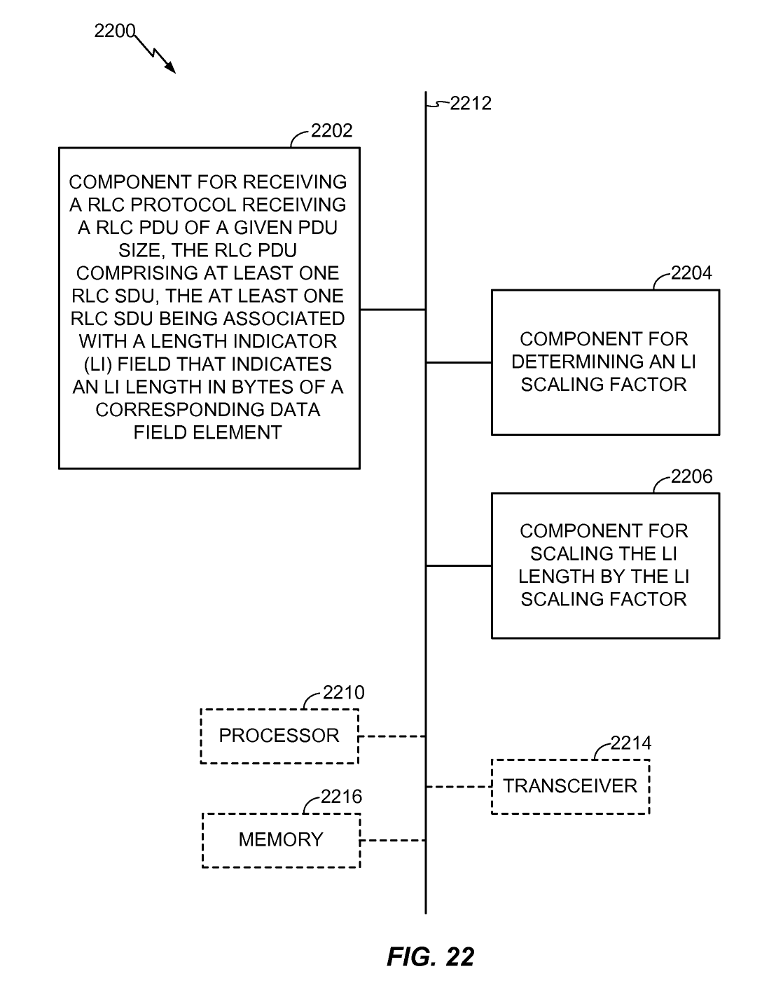

In accordance with one or more aspects of the embodiments described herein, there are provided devices and apparatuses (e.g., eNBs) for RLC, as described above with reference to FIG. 21. With reference to FIG. 22, the apparatus 2200 may include: an electrical component or module 2202 for receiving a RLC PDU of a given PDU size, the RLC PDU comprising at least one RLC SDU, the at least one RLC SDU being associated with a length indicator (LI) field that indicates an LI length in bytes of a corresponding data field element; a component 2204 for determining an LI scaling factor; and a component 2206 for scaling the LI length by the LI scaling factor. It is noted that the component 2202 may be, or may include, a means for receiving a RLC PDU of a given PDU size. Said means may be or may include the at least one receiver (e.g., the MIMO detector 336 and/or receive processor 338 of FIG. 3). The components 2204-2206 may include a means for determining an LI scaling factor and a means for scaling the LI length by the LI scaling factor. Said means may be or may include at least one control processor (e.g., the controller/processor 340 of FIG. 3) operating an algorithm. The algorithm may include requesting the operator to select a scaling factor or consulting a database or memory to determine the scaling factor (e.g., 8). The algorithm may further include reading the PDU header to determine the indicated LI length (e.g., 188 bytes), and then multiplying the indicated LI length by the scaling factor obtained in the previous step (e.g., 188 bytes multiplied by 8). For the sake of conciseness, the rest of the details regarding apparatus 2200 are not further elaborated on; however, it is to be understood that the remaining features and aspects of the apparatus 2200 are substantially similar to those described above with respect to apparatus 1800 of FIG. 18.

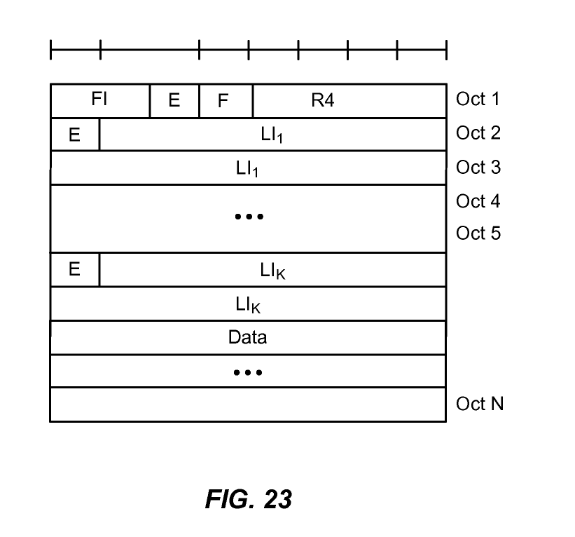

NEW RLC HEADER FORMAT: In accordance with one or more aspects of the embodiments described herein, there is provided a technique for adding a new RLC UM header (hdr) with a longer LI bitwidth. For example, with reference to FIG. 23, the LI bit width may be expanded from 11 bits to 15 bits. The LI bit width may be expanded even more for a 5 bits SN header or a 10 bits SN header. In related aspects, a 4 bit reserved header with an F field may be used as the LI Format field size indicator. For example, when F=0 then LI may contain 11 bits, or when F=1 then LI may contain 15 bits.

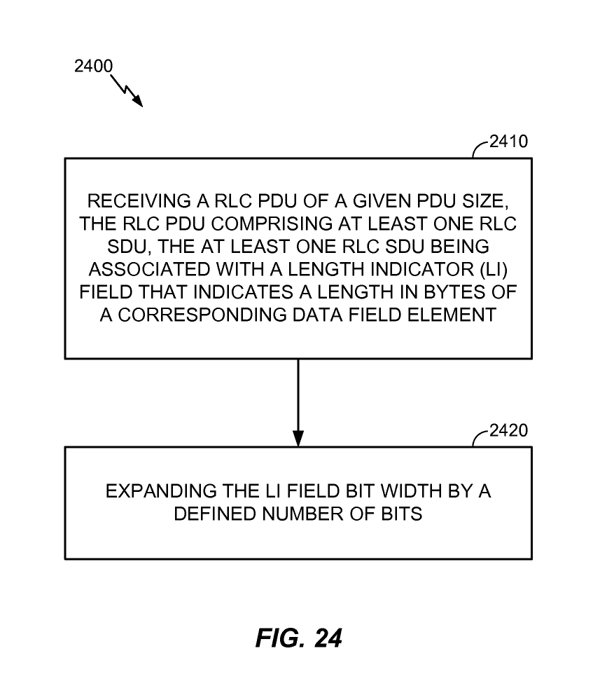

With reference to FIG. 24, illustrated is an RLC methodology 2400 for MBMS or the like that may be performed at a network entity, such as, for example, an eNB or the like. The method 2400 may involve: receiving a RLC PDU of a given PDU size, the RLC PDU comprising at least one RLC SDU, the at least one RLC SDU being associated with a length indicator (LI) field that indicates a length in bytes of a corresponding data field element (block 2410); and expanding the LI field bit width by a defined number of bits (block 2420). In related aspects, expanding may involve utilizing an SN header of the RLC PDU. For example, since 11 bits cannot hold a IP packet, the network entity may use the same bit-width as the length field in the IP header or the user datagram protocol (UDP) header, such as, for example, 16 bits. The RLC SDU typically carries a PDCP or IP packet. The length field may be made the same as a packet from the upper layers.

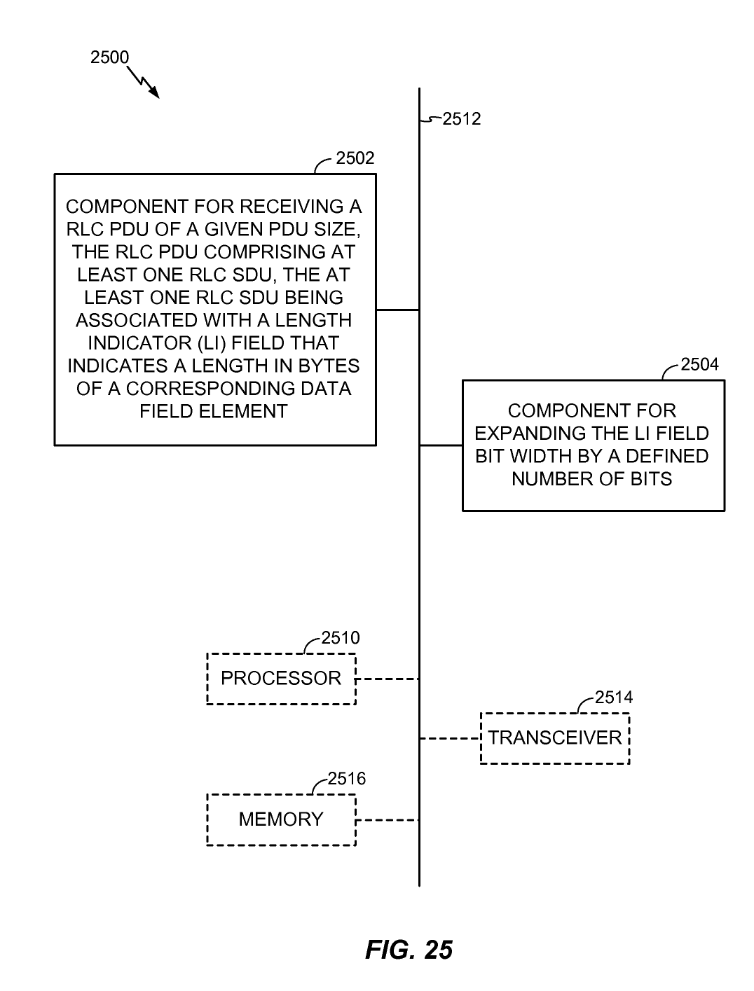

In accordance with one or more aspects of the embodiments described herein, there are provided devices and apparatuses (e.g., eNBs) for RLC, as described above with reference to FIG. 24. With reference to FIG. 25, the apparatus 2500 may include: an electrical component or module 2502 for receiving a RLC PDU of a given PDU size, the RLC PDU comprising at least one RLC SDU, the at least one RLC SDU being associated with a length indicator (LI) field that indicates a length in bytes of a corresponding data field element; and a component 2504 for expanding the LI field bit width by a defined number of bits. For the sake of conciseness, the rest of the details regarding apparatus 2500 are not further elaborated on; however, it is to be understood that the remaining features and aspects of the apparatus 2500 are substantially similar to those described above with respect to apparatus 1800 of FIG. 18.

LIMIT MAXIMUM RLC SDU SIZE AT UPPER LAYER FOR MBMS: With reference once again to FIG. 13, in accordance with one or more aspects of the embodiments described herein, there is provided a technique for limiting the maximum UM RLC SDU size to be less than or equal to a defined size limit (e.g., 2K bytes) for eMBMS since PDCP is not used for MTCH or MCCH. For example, the BM-SC or the like may make sure that all the encoder data packet send over SYNC over IP is less than or equal to 2K bytes. Each packet may be mapped to an RLC SDU.

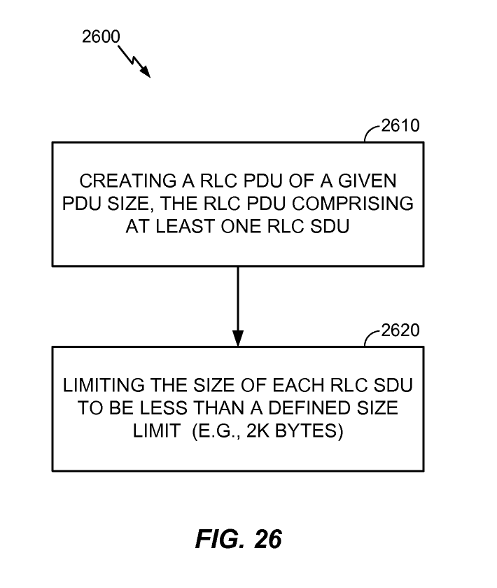

With reference to FIG. 26, illustrated is an RLC methodology 2600 for MBMS or the like that may be performed at a network entity, such as, for example, an a broadcast multicast-service center (BM-SC) or the like. The method 2600 may involve: creating a RLC PDU of a given PDU size, the RLC PDU comprising at least one RLC SDU (block 2610), wherein creating further involve limiting the size of each RLC SDU to be less than a defined size limit (e.g., 2K bytes) (block 2620).

In related aspects, limiting may involve limiting each encoder data packet to be sent over SYNC over IP to be less than the defined size limit, or limiting each encoder data packet to be sent over SYNC over IP to be less than the defined size limit Limiting each encoder data packet may further involve mapping each encoder packet to a corresponding RLC SDU.

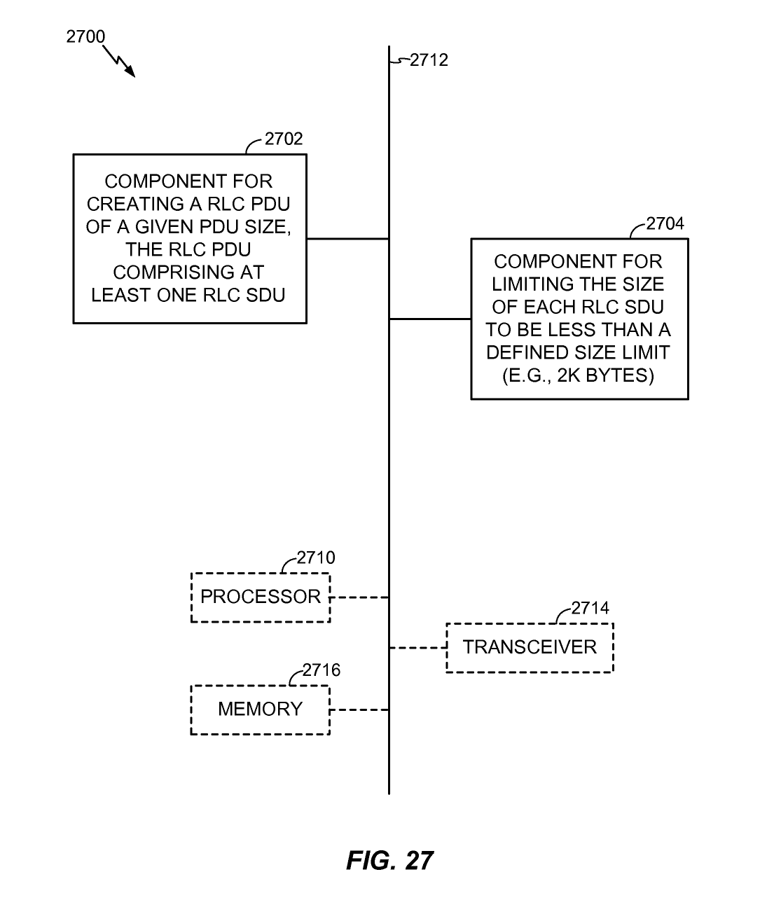

In accordance with one or more aspects of the embodiments described herein, there are provided devices and apparatuses (e.g., BM-SCs) for RLC, as described above with reference to FIG. 26. With reference to FIG. 27, the apparatus 2700 may include: an electrical component or module 2702 for creating a RLC PDU of a given PDU size, the RLC PDU comprising at least one RLC SDU; and a component 2704 for limiting the size of each RLC SDU to be less than a defined size limit. For the sake of conciseness, the rest of the details regarding apparatus 2700 are not further elaborated on; however, it is to be understood that the remaining features and aspects of the apparatus 2700 are substantially similar to those described above with respect to apparatus 1800 of FIG. 18.

RLC SYNCHRONIZATION: In accordance with one or more aspects of the embodiments described herein, there is provided a technique for synchronous RLC, wherein an eNB RLC sender in general may create RLC PDUs of any length it desires. In order to ensure SFN synchronization across eNBs there is a need to specify when and how each eNB shall generate an RLC PDU, thereby achieving RLC synchronized operation for SFN across eNBs. For example, if the RLC SDU's size is beyond 2047 bytes, then the RLC PDU may be delivered to lower layer as soon as the end of an RLC SDU is reached. Otherwise, an RLC PDU is created as large as possible while still fitting into a defined MAC transport block, or the RLC PDU is created as soon as the PDU's data length field size exceeds the defined size limit (e.g., 2047 bytes). The other eNBs in an MBSFN area may perform segmentation in the same way. For the same logical channel, it may be more efficient to create less RLC PDUs, wherein one RLC PDU is preferred but multiple RLC PDUs are acceptable.

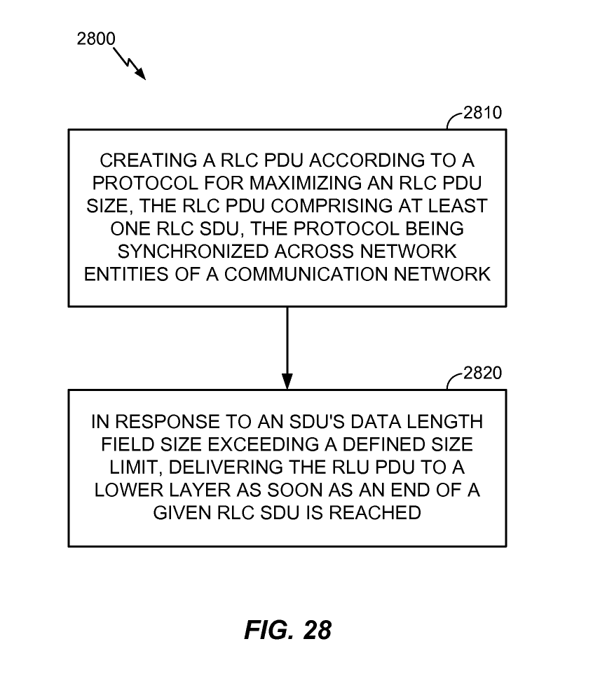

With reference to FIG. 28, illustrated is a synchronous RLC methodology 2800 for MBMS or the like that may be performed at a network entity, such as, for example, an eNB or the like. The method 2800 may involve: creating a RLC PDU according to a protocol for maximizing an RLC PDU size, the RLC PDU comprising at least one RLC SDU, the protocol being synchronized across network entities of a communication network (block 2810); and in response to an SDU's data length field size exceeding a defined size limit, delivering the RLC PDU to a lower layer as soon as an end of a given RLC SDU is reached (2820). It is noted that the eNBs in the network that participate in the broadcast need to segment packets in the same way at the same time. Thus, the eNB operations are synchronized. The eNBS may be preconfigured with information regarding which protocol will be used to do the segmentation. The eNBs may also receive data from the network in a synchronous fashion via a SYNC protocol or the like.

In related aspects, creating may involve making the RLC PDU as large as possible while still fitting into a defined MAC transport block. Creating may involve creating the RLC PDU as soon as the SDU's data length field size exceeds the defined size limit.

In another embodiment, there is provided a method for synchronous MAC operation, involving: generating a RLC PDU according to a protocol for maximizing an RLC PDU size, the RLC PDU comprising at least one RLC service data unit (SDU), the protocol being synchronized across network entities of a communication network. The method may further involve determining how much space remains in a MAC PDU in view of the generated RLC PDU; and in response to the space being less than a defined value (e.g., 2, 3, or more bytes), filling the space with MAC padding. In related aspects, the method may further involve refraining from requesting or using any subsequent PDUs to fill the space.

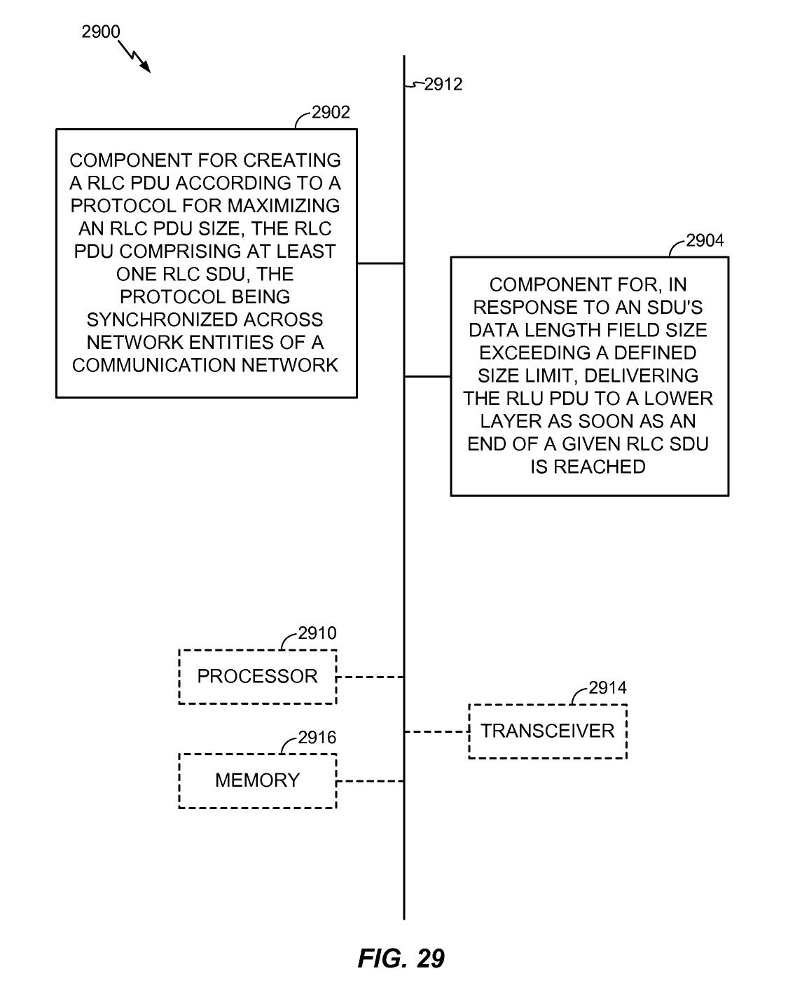

In accordance with one or more aspects of the embodiments described herein, there are provided devices and apparatuses (e.g., eNBs) for synchronous RLC, as described above with reference to FIG. 28. With reference to FIG. 29, the apparatus 2900 may include: an electrical component or module 2902 for creating a RLC PDU according to a protocol for maximizing an RLC PDU size, the RLC PDU comprising at least one RLC service data unit (SDU), the protocol being synchronized across network entities of a communication network; and a component 2904 for delivering the RLC PDU to a lower layer as soon as an end of a given RLC SDU is reached, in response to an SDU's data length field size exceeding a defined size limit. For the sake of conciseness, the rest of the details regarding apparatus 2900 are not further elaborated on; however, it is to be understood that the remaining features and aspects of the apparatus 2900 are substantially similar to those described above with respect to apparatus 1800 of FIG. 18.

SETTING MAXIMUM SIZE FOR TBS: In accordance with one or more aspects of the embodiments described herein, there is provided a technique for using the modulating coding scheme (MCS) to limit the transport block (TB) size (for eMBMS or the like) to be less than a selected maximum value, such as, for example, 2K bytes (or 16376 bits). For example, with reference to the TBS lookup tables in FIGS. 10A-B, which limits the max MCS index to be 27 for 25 RBs, to be 17 for 50 RB, to be 12 for 75 RB, and to be 10 for 100 RB. In the example of FIG. 10A, the maximum possible MCS index is 28.

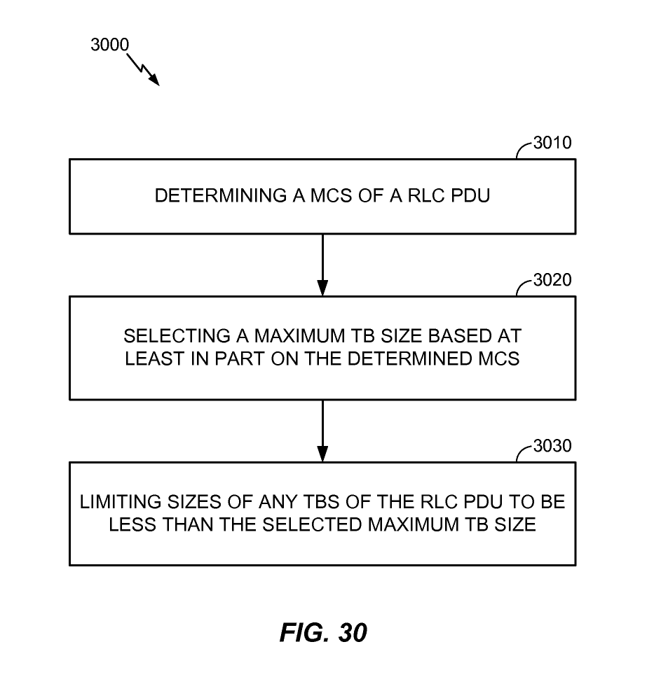

With reference to FIG. 30, illustrated is an RLC methodology 3000 for MBMS or the like that may be performed at a network entity, such as, for example, an eNB or the like. The method 3000 may involve: determining a MCS of a RLC PDU (block 3010); selecting a maximum TB size based at least in part on the determined MCS (block 3020); and limiting sizes of any TBs of the RLC PDU to be less than the selected maximum TB size (block 3030). In related aspects, determining the MCS may involve determining at least one of an MCS index, a modulator order, and a TB size index for the RLC PDU.

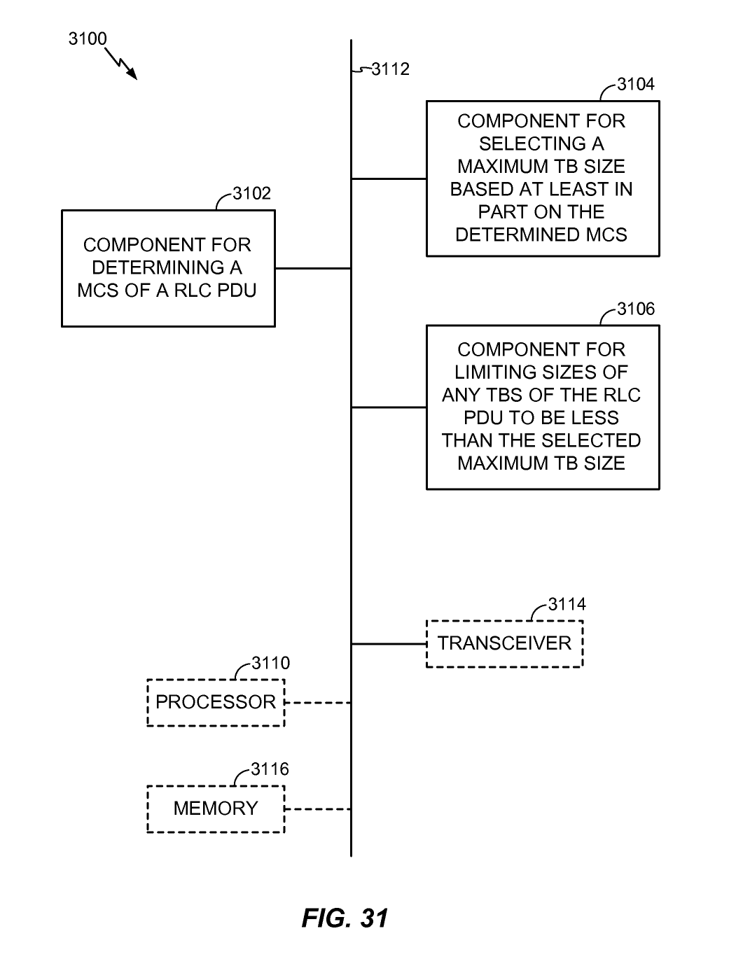

In accordance with one or more aspects of the embodiments described herein, there are provided devices and apparatuses (e.g., eNBs) for RLC, as described above with reference to FIG. 30. With reference to FIG. 31, the apparatus 3100 may include: an electrical component or module 3102 for determining a MCS of a RLC PDU; a component 3104 for selecting a maximum TB size based at least in part on the determined MCS; and a component 3106 for limiting sizes of any TBs of the RLC PDU to be less than the selected maximum TB size. The components 3102-3106 may include a means for determining a MCS of a RLC PDU, a means for selecting a maximum TB size based at least in part on the determined MCS, and a means for limiting sizes of any TBs of the RLC PDU to be less than the selected maximum TB sizes. Said means may be or may include at least one control processor (e.g., the controller/processor 340 of FIG. 3) operating an algorithm. The algorithm may include receiving instructions from the operator regarding the assignment of a MCS to the RLC PDU, selecting the MCS based on a given characteristic of the RLC PDU, or selecting a default MCS. It is noted that the MCS may be selected by a controller in the network (e.g., an MCE or the like). The algorithm may include accessing a database or memory to consult a first table that lists different transport block size (TBS) indices for different MCS indices (e.g., the table in FIG. 10A), as well as a second table that lists different maximum sizes for the TBS based on the TBS indices and the number of physical resource blocks (e.g., the table in FIG. 10B). The algorithm may include verifying that the size of any TBS is less than the maximum size selected from the second table. For the sake of conciseness, the rest of the details regarding apparatus 3100 are not further elaborated on; however, it is to be understood that the remaining features and aspects of the apparatus 3100 are substantially similar to those described above with respect to apparatus 1800 of FIG. 18.

LIMIT RLC SDU SIZE TO LESS THAN A DEFINED SIZE LIMIT FOR ALL EXCEPT THE LAST RLC SDU: In accordance with one or more aspects of the embodiments described herein, there is provided a technique for limiting the sizes of the RLC SDUs. It is possible to concatenate the RLC SDUs as long as the RLC SDU size is less than a defined size limit (e.g., 2K bytes). Once a given RLC SDU with length larger than the defined size limit is detected, the given RLC SDU may be left as the last RLC SDU for the RLC PDU. Padding may be included as needed. With this technique, a LI is not needed because the last RLC SDU with a PDU does not need a header extension (E|LI). For example, with reference once again to FIG. 13, the first k SDUs' length are put in LI, whereas the last k+1 SDU (or SDU segment) does not need the LI, which can be derived.

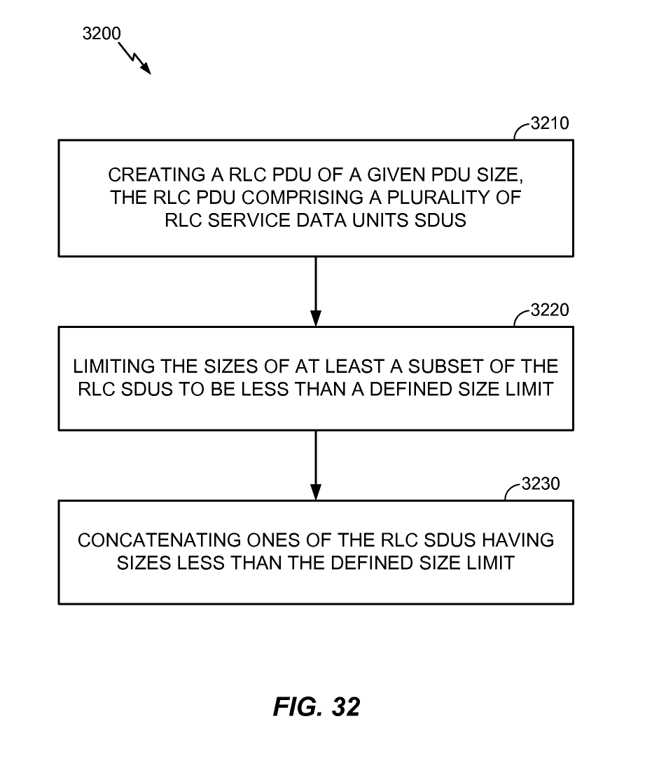

With reference to FIG. 32, illustrated is an RLC methodology 3200 for MBMS or the like that may be performed at a network entity, such as, for example, an eNB or the like. The method 3200 may involve creating a RLC PDU of a given PDU size, the RLC PDU comprising a plurality of RLC SDUs (block 3210). Creating may involve: limiting the sizes of at least a subset of the RLC SDUs to be less than a defined size limit (block 3220); and concatenating ones of the RLC SDUs having sizes less than the defined size limit (block 3230). In related aspects, the method 3200 may further involve, in response to detecting a given RLC SDU having a SDU size that meets or exceeds the defined size limit, including the given RLC SDU as a last RLC SDU of the RLC PDU. It is noted that once the RLC PDU is created, the RLC PDU may or may not be immediately transmitted, depending on whether the MAC includes the other RLC PDUs in the MAC PDU.

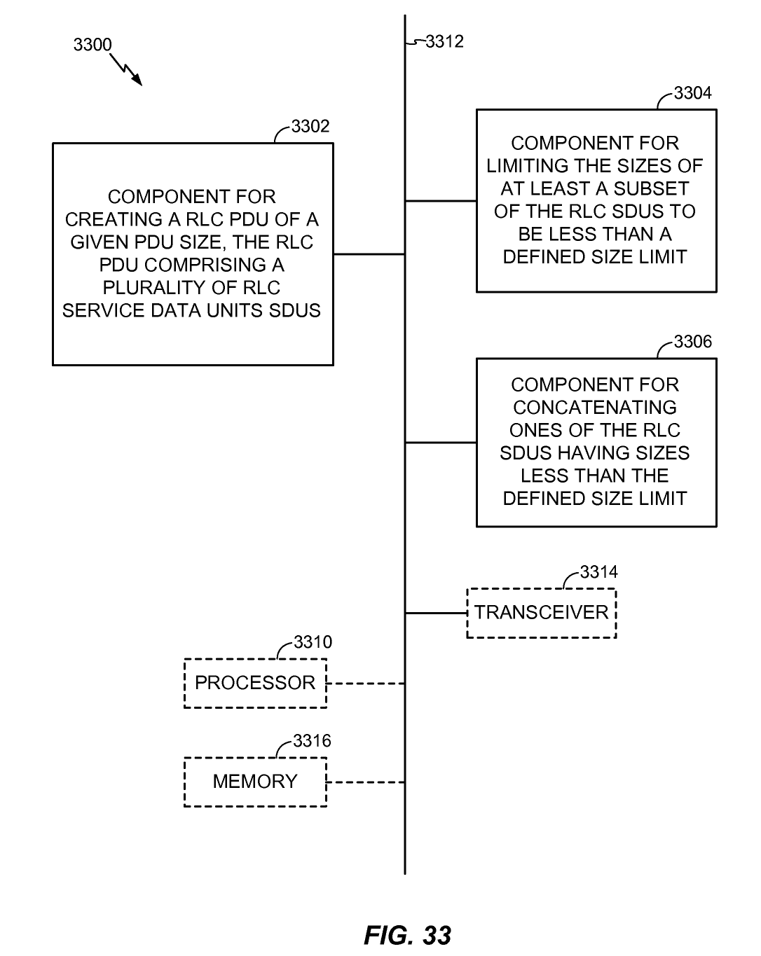

In accordance with one or more aspects of the embodiments described herein, there are provided devices and apparatuses (e.g., eNBs) for RLC, as described above with reference to FIG. 32. With reference to FIG. 33, the apparatus 3300 may include: an electrical component or module 3302 for creating a RLC PDU of a given PDU size, the RLC PDU comprising a plurality of RLC SDUs; a component 3304 for limiting the sizes of at least a subset of the RLC SDUs to be less than a defined size limit; and a component 3306 for concatenating ones of the RLC SDUs having sizes less than the defined size limit. The components 3302-3306 may include a means for creating a RLC PDU of a given PDU size, a means for limiting the sizes of at least a subset of the RLC SDUs to be less than a defined size limit, and a means for concatenating ones of the RLC SDUs having sizes less than the defined size limit. Said means may be or may include at least one control processor (e.g., the controller/processor 340 of FIG. 3) operating an algorithm. The algorithm may include receiving the defined size limit from the operator, selecting the size limit based on a given characteristic of the RLC SDUs, or using a default size limit. The algorithm may include selecting those RLC SDUs sizes less than the defined size limit. The algorithm may include breaking up those RLC SDUs with sizes greater than the defined size limit into smaller RLC SDUs, or discarding those RLC SDUs with sizes greater than the defined size limit, before concatenating those RLC SDUs having sizes less than the defined size limit. For the sake of conciseness, the rest of the details regarding apparatus 3300 are not further elaborated on; however, it is to be understood that the remaining features and aspects of the apparatus 3300 are substantially similar to those described above with respect to apparatus 1800 of FIG. 18.

MAPPING ONE SYNC DATA PDU TO THE RLC PDU: With reference once again to FIG. 12, in accordance with one or more aspects of the embodiments described herein, there is provided a technique for mapping one SYNC Data PDU (minus SYNC header, and GTPv1 header, wherein SYNC Control PDUs are not counted) to the RLC SDU. Then one RLC SDU is mapped to the RLC PDU, so it uses the RLC header below without the LI field. Multiple RLC PDUs may be packed into one MAC PDU.

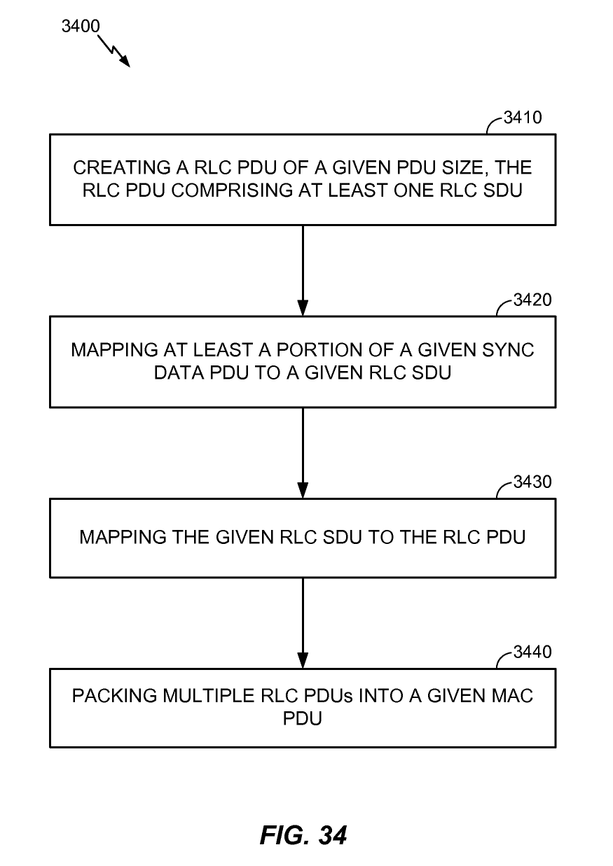

With reference to FIG. 34, illustrated is an RLC methodology 3400 for MBMS or the like that may be performed at a network entity, such as, for example, an eNB or the like. The method 3400 may involve creating a RLC PDU of a given PDU size, the RLC PDU comprising at least one RLC SDU (block 3410). Creating may involve: mapping at least a portion of a given SYNC data PDU to a given RLC SDU (block 3420); mapping the given RLC SDU to the RLC PDU (block 3430); and packing multiple RLC PDUs into a given MAC PDU (block 3440).

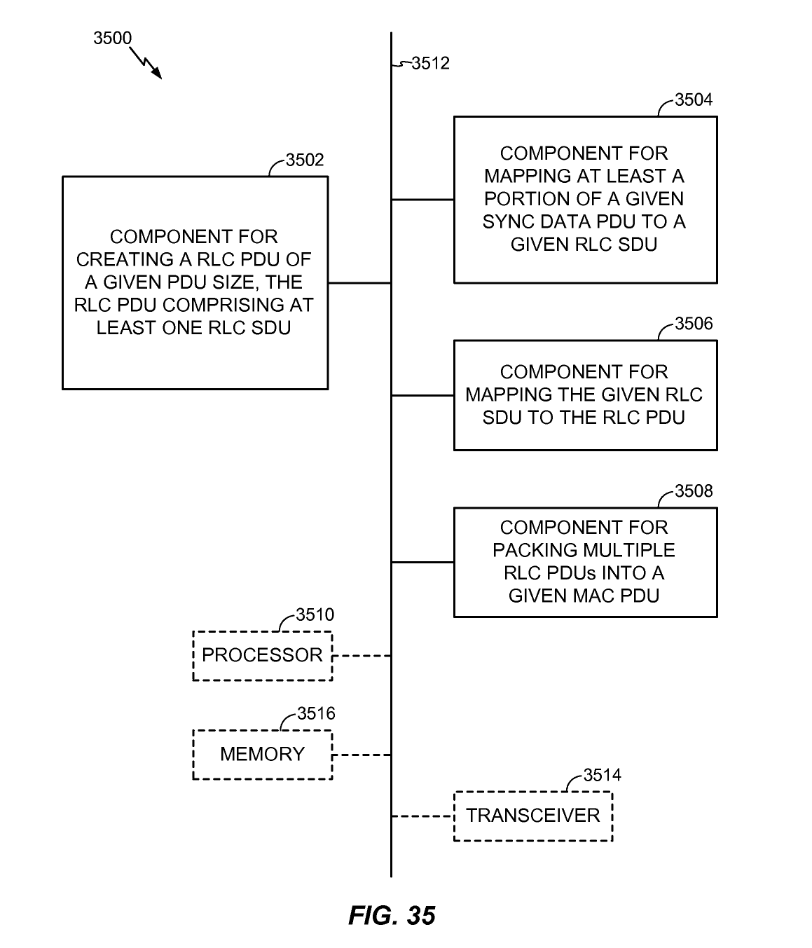

In accordance with one or more aspects of the embodiments described herein, there are provided devices and apparatuses (e.g., eNBs) for RLC, as described above with reference to FIG. 34. With reference to FIG. 35, the apparatus 3500 may include: an electrical component or module 3502 for creating a RLC PDU of a given PDU size, the RLC PDU comprising at least one RLC SDU; a component 3504 for mapping at least a portion of a given SYNC data PDU to a given RLC SDU; a component 3506 for mapping the given RLC SDU to the RLC PDU; and a component 3508 for packing multiple RLC PDUs into a given MAC PDU. The components 3502-3508 may include a means for creating a RLC PDU of a given PDU size, a means for mapping at least a portion of a given SYNC data PDU to a given RLC SDU, a means for mapping the given RLC SDU to the RLC PDU, and a means for packing multiple RLC PDUs into a given MAC PDU. Said means may be or may include at least one control processor (e.g., the controller/processor 340 of FIG. 3) operating an algorithm. The algorithm may include consulting a database or memory that includes a first table listing RLC SDUs for different SYNC data PDUs. The algorithm may include consulting a database or memory that includes a second table listing RLC PDUs for different RLC SDUs. The algorithm may include packing the multiple RLC PDUs based on the first and second tables. For the sake of conciseness, the rest of the details regarding apparatus 3500 are not further elaborated on; however, it is to be understood that the remaining features and aspects of the apparatus 3500 are substantially similar to those described above with respect to the apparatus 1800 of FIG. 18.

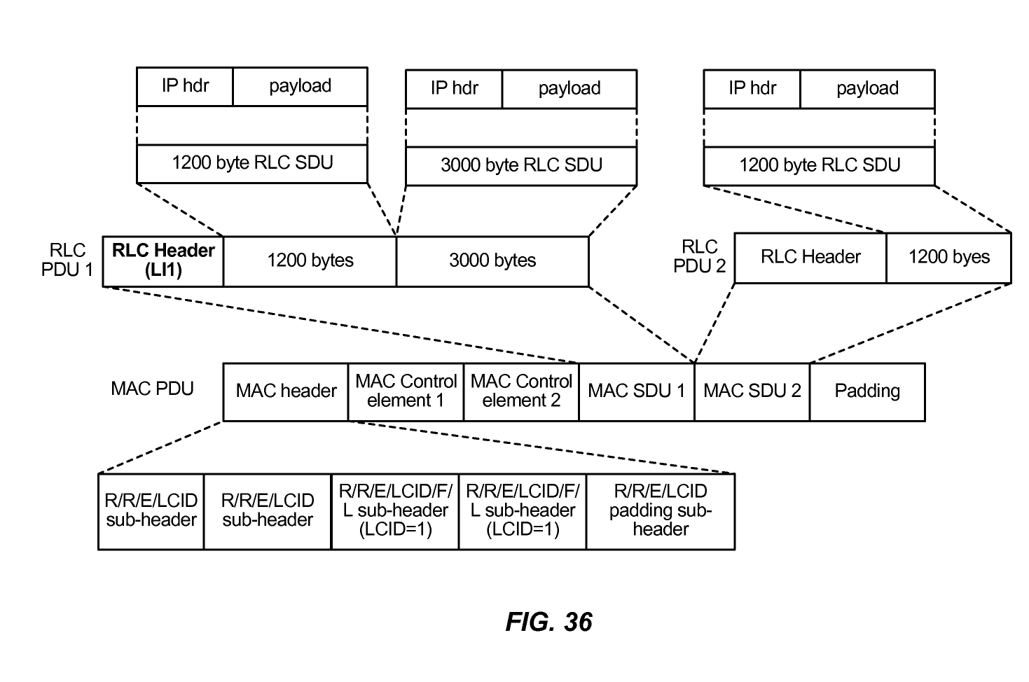

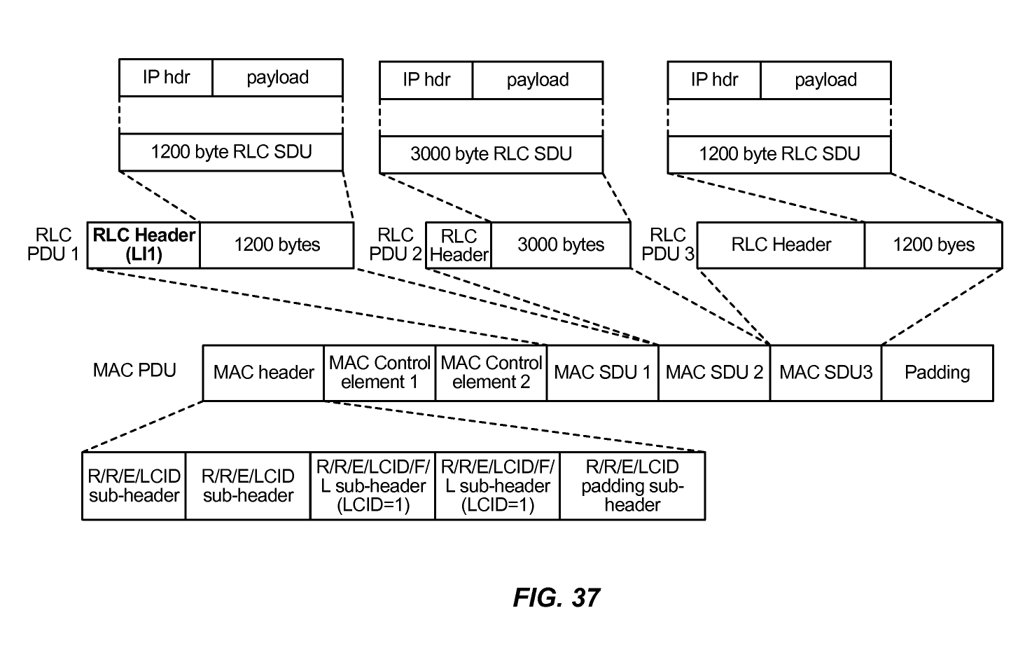

SYNCHRONIZED RLC/MAC OPERATION FOR eMBMS: In accordance with one or more aspects of the embodiments described herein, there are provided techniques for RLC synchronization and MAC synchronization. With respect to RLC synchronization, if the RLC SDU's size is not greater than 2047 bytes, the RLC may rely on concatenation and segmentation to create an RLC PDU as large as possible. Otherwise, no RLC SDU concatenation occurs after this SDU in the RLC PDU. In other words, the eNB's RLC concatenates as many RLC SDUs from the same logical channel as possible into a MAC PDU. The RLC SDU segment can be concatenated at the beginning or ending of a RLC PDU. With respect to MAC Synchronization, the eNB's MAC layer multiplexes as many RLC PDUs (or MAC SDUs) as fit in the MAC PDU. With the above rules for RLC/MAC synchronization, eNBs participating in an eMBMS transmission will form the same RLC/MAC PDU(s) as shown in the example of FIG. 36. In FIG. 36, there is shown MAC SDU 1, which includes a first RLC SDU segment of size 1200 bytes concatenated with a second RLC SDU segment of size 3000 bytes. Because the 3000 bytes exceeds the size limit of 2047 bytes, the second RLC SDU segment is attached to the first RLC SDU segment and the resulting RLC PDU is delivered to the lower layer as MAC SDU 1. As such, another RLC PDU (i.e., RLC PDU 2) is created only after the size limit of 2047 bytes is exceeded, thereby utilizing RLC PDUs of the maximum size permitted. Without the above rules for RLC/MAC synchronization, multiple types of RLC/MAC PDU formation may result, as shown in the examples of both FIGS. 36 and 37. With reference to FIG. 37, the size of each RLC PDU is not maximized according to the methodology implemented in FIG. 36. As such, there are more MAC SDUs (e.g., three instead of two MAC SDUs), wherein the size of the MAC SDUs are not maximized (e.g., the size of RLC PDU 1 is not maximized, in contrast to the corresponding RLC PDU 1 of FIG. 36). Not being able to maximize the RLC PDU size or MAC SDU size may introduce more header overhead, resulting in inefficient system resource utilization.

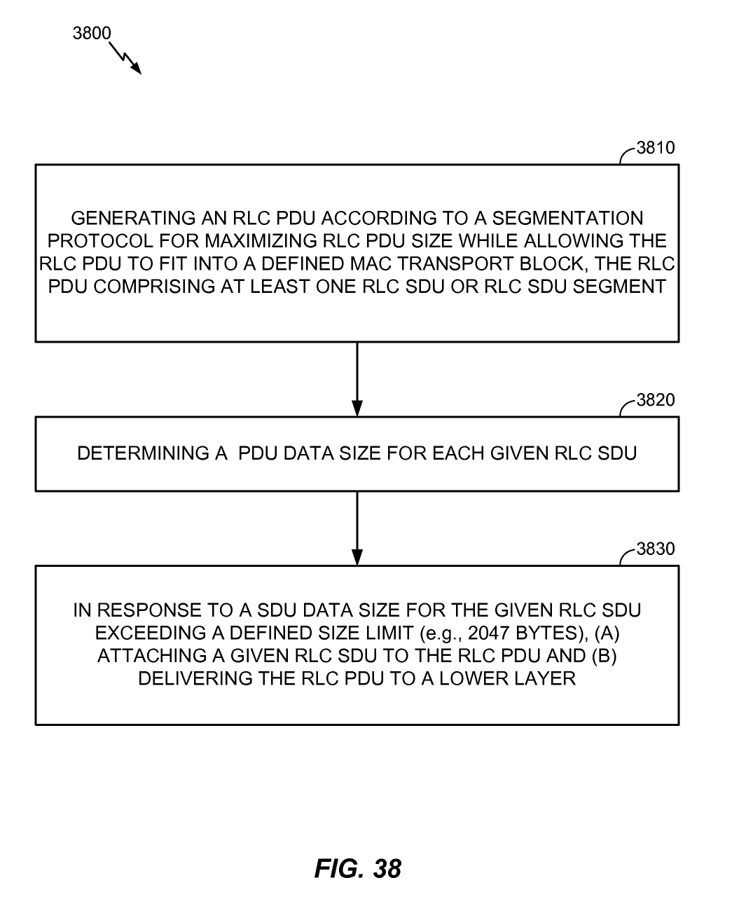

With reference to FIG. 38, illustrated is a methodology 3800 for synchronized RLC operation that may be performed at a network entity, such as, for example, an eNB or the like. The method 3800 may involve, at 3810, generating an RLC PDU according to a segmentation protocol for maximizing RLC PDU size while allowing the RLC PDU to fit into a defined MAC transport block, the RLC PDU comprising at least one RLC SDU or RLC SDU segment. The method 3800 may involve, at 3820, determining a PDU data size for each given RLC SDU. The method 3800 may involve, at 3830, (a) attaching a given RLC SDU to the RLC PDU and (b) delivering the RLC PDU to a lower layer, in response to a SDU data size for the given RLC SDU exceeding a defined size limit (e.g., 2047 bytes). Each of the network entities may perform the segmentation operations in the same way. One way of accomplishing this is to preconfigure the segmentation algorithm/protocol used by the eNBs. If the given LC SDU does not exceed the defined size limit, the method 3800 may involve continuing to concatenate RLC SDUs until a given one of the RLC SDUs exceeds the define size limit. In related aspects, generating (block 3820) may involve maximizing RLC PDU length while allowing the RLC PDU to fit into a defined MAC transport block. In further related aspects, the method 3800 may involve receiving an indication or information regarding a synchronization protocol for synchronizing the segmentation protocol in block 3810. In yet further related aspects, the method 3800 may involve synchronizing the protocol across the network entities participating in the broadcast service.

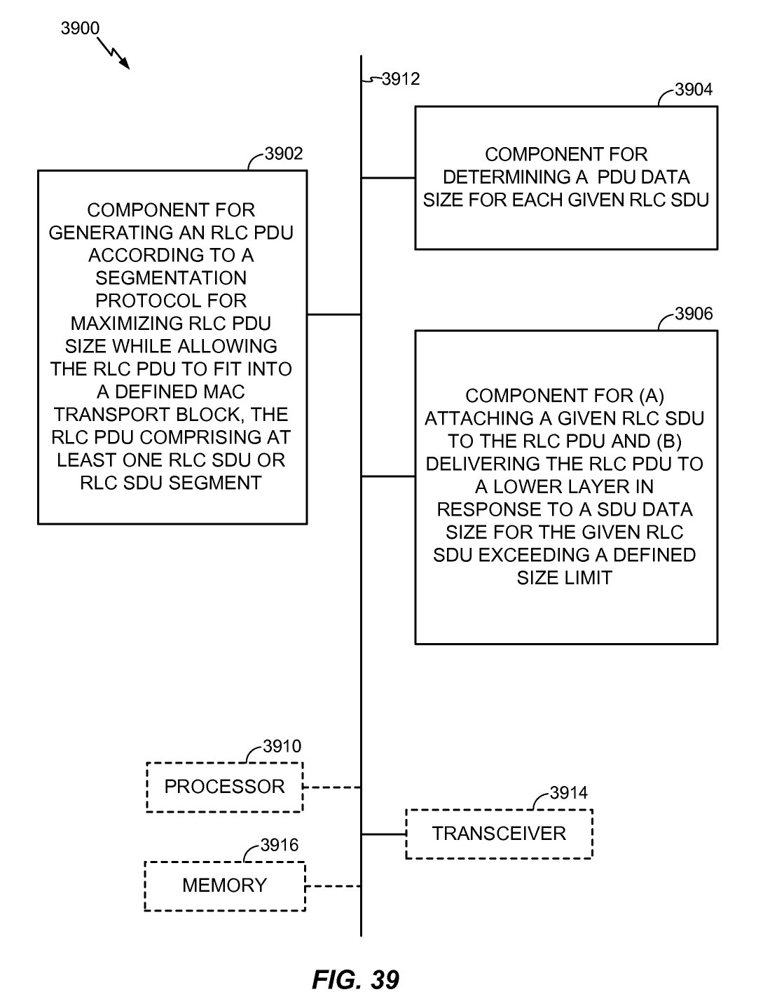

In accordance with one or more aspects of the embodiments described herein, there are provided devices and apparatuses (e.g., eNBs) for RLC, as described above with reference to FIG. 38. With reference to FIG. 39, the apparatus 3900 may include: an electrical component or module 3902 for generating an RLC PDU according to a segmentation protocol for maximizing RLC PDU size while allowing the RLC PDU to fit into a defined MAC transport block, the RLC PDU comprising at least one RLC SDU or RLC SDU segment. The apparatus 3900 may include a component 3904 for determining a PDU data size for each given RLC SDU. The apparatus 3900 may include a component 3906 for (a) attaching a given RLC SDU to the RLC PDU and (b) delivering the RLC PDU to a lower layer, in response to a SDU data size for the given RLC SDU exceeding a defined size limit. The components 3902-3906 may include a means for synchronizing a segmentation protocol for maximizing RLC PDU size across a group of network entities, a means for generating an RLC PDU according to the protocol, a means for determining a PDU data size for each given RLC SDU, and a means for, in conjunction with each of the other network entities of the group, (a) attaching a given RLC SDU to the RLC PDU and (b) delivering the RLC PDU to a lower layer in response to a SDU data size for the given RLC SDU exceeding a defined size limit Said means may be or may include at least one control processor (e.g., the controller/processor 340 of FIG. 3) operating an algorithm. The algorithm may include sending and/or receiving the segmentation protocol to the other network entities. The algorithm may include generating the RLC PDU according to the sent/received protocol. The algorithm may include determining whether the given RLC SDU exceeds the defined size limit. The algorithm may include performing block 3840 or, if the given LC SDU does not exceed the defined size limit, continuing to concatenate RLC SDUs until a given one of the RLC SDUs exceeds the define size limit (e.g., 2047 bytes). The algorithm may include performing block 3840 once a given one of the RLC SDUs exceeds the define size limit. In related aspects, the algorithm may include making the RLC PDU as large as possible while still fitting into a given MAC transport block. For the sake of conciseness, the rest of the details regarding apparatus 3900 are not further elaborated on; however, it is to be understood that the remaining features and aspects of the apparatus 3900 are substantially similar to those described above with respect to the apparatus 1800 of FIG. 18.

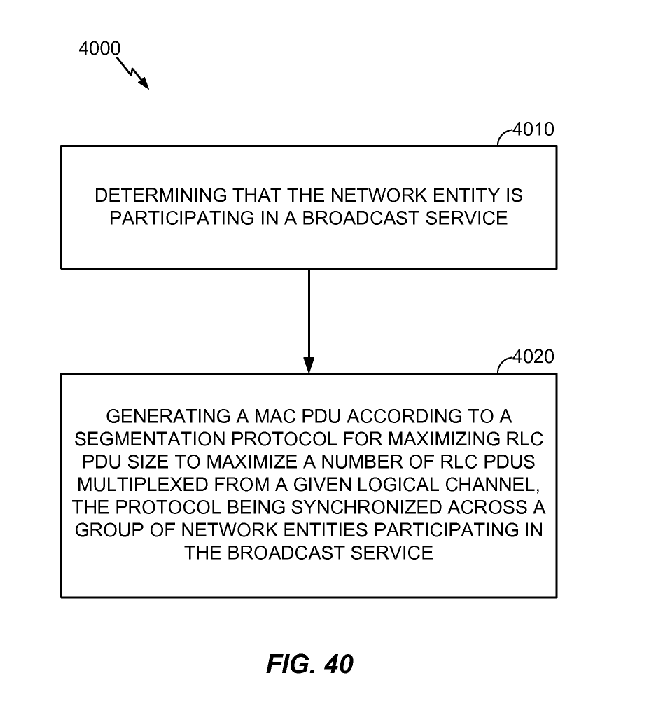

With reference to FIG. 40, illustrated is a methodology 4000 for synchronized MAC operation that may be performed at a network entity, such as, for example, an eNB or the like. The method 4000 may involve, at 4010, determining that the network entity is participating in a broadcast service. The method 4000 may involve, at 4020, generating a MAC PDU according to a segmentation protocol for maximizing RLC PDU size to maximize a number of RLC PDUs multiplexed from a given logical channel, the protocol being synchronized across a group of network entities participating in the broadcast service.

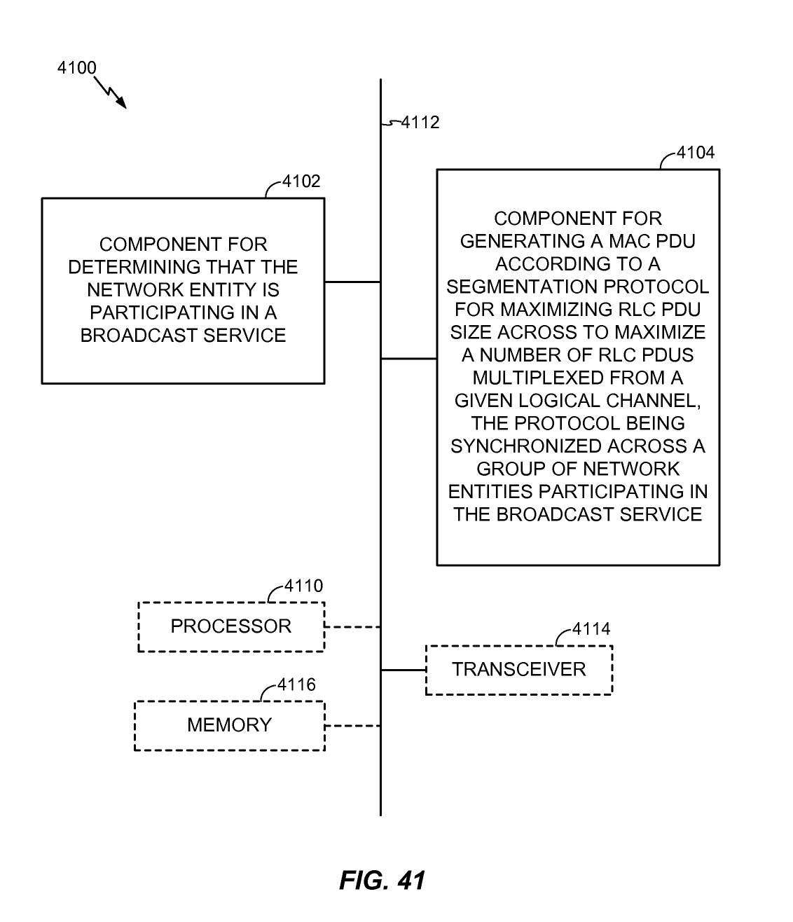

In related aspects, there are provided devices and apparatuses (e.g., eNBs) for MAC operation, as described above with reference to FIG. 40. With reference to FIG. 41, the apparatus 4100 may include an electrical component or module 4102 for determining that the network entity is participating in a broadcast service. The apparatus 4100 may include an electrical component 4104 for generating a MAC PDU according to a segmentation protocol for maximizing RLC PDU size across to maximize a number of RLC PDUs multiplexed from a given logical channel, the protocol being synchronized across a group of network entities participating in the broadcast service. The components 4102-4104 may include a means for synchronizing a segmentation protocol for maximizing of RLC PDU size across a group of network entities participating in a broadcast service, and a means for generating a MAC PDU according to the protocol to maximize a number of RLC PDUs multiplexed from a given logical channel. Said means may be or may include at least one control processor (e.g., the controller/processor 340 of FIG. 3) operating an algorithm. The algorithm may include sending and/or receiving the segmentation protocol to the other network entities. The algorithm may include generating the MAC PDU according to the sent/received protocol. The algorithm may include verifying that the number of RLC PDUs multiplexed from the given logical channel has been maximized. For the sake of conciseness, the rest of the details regarding apparatus 4100 are not further elaborated on; however, it is to be understood that the remaining features and aspects of the apparatus 4100 are substantially similar to those described above with respect to the apparatus 1800 of FIG. 18.

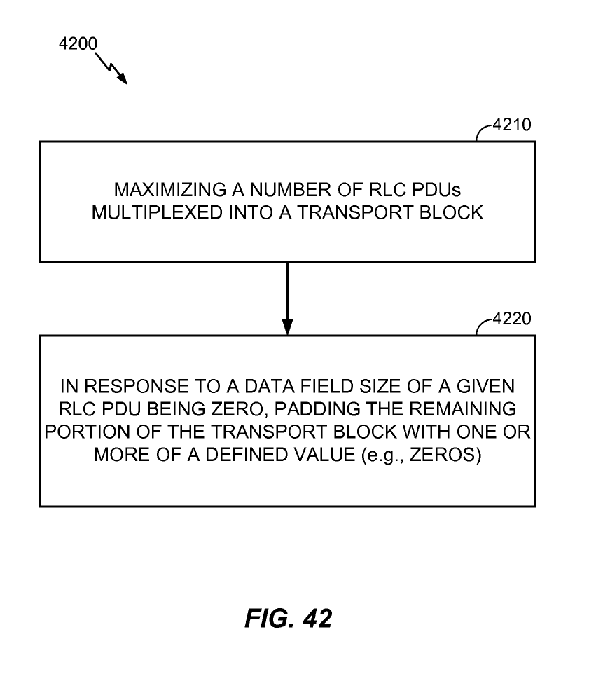

With reference to FIG. 42, illustrated is a methodology 4200 for synchronized MAC operation that may be performed at a network entity, such as, for example, an eNB or the like. The method 4200 may involve, at 4210, maximizing a number of RLC PDUs multiplexed into a transport block. The method 4200 may involve, at 4220, in response to a data field size of a given RLC PDU being zero, padding the remaining portion of the transport block with one or more of a defined value (e.g., zeros). In related aspects, block 4220 may involve padding the remaining portion of the transport block with zeroes, instead of multiplexing the given RLC PDU into the transport block.

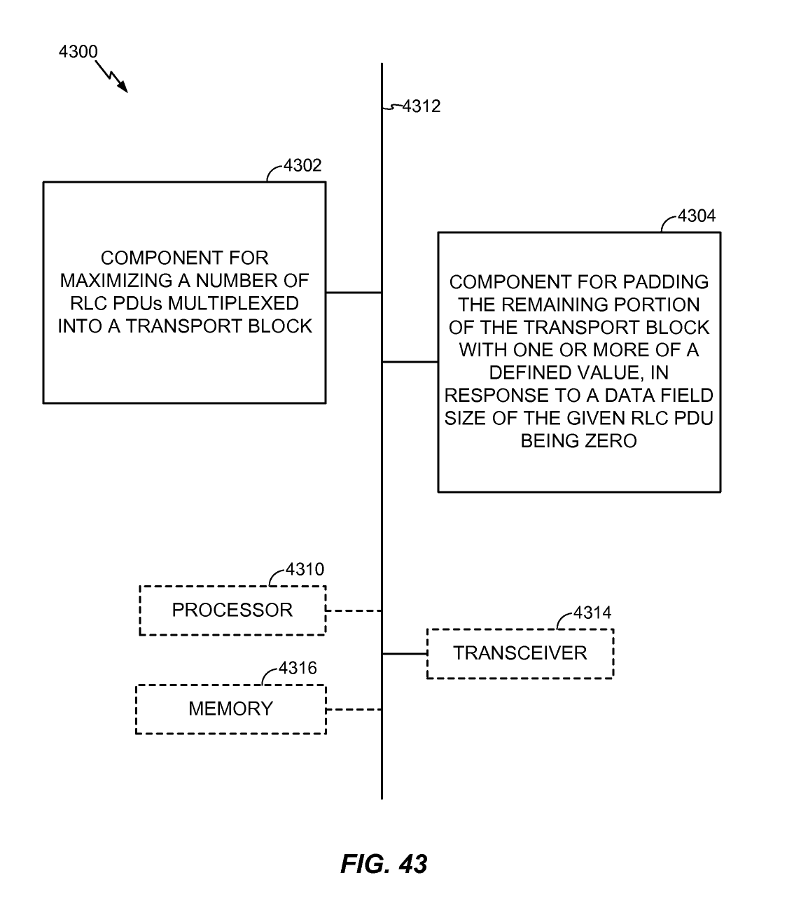

In related aspects, there are provided devices and apparatuses (e.g., eNBs) for MAC operation, as described above with reference to FIG. 42. With reference to FIG. 43, the apparatus 4300 may include an electrical component or module 4302 for maximizing a number of RLC PDUs multiplexed into a transport block. The apparatus 4300 may include an electrical component 4304 for padding the remaining portion of the transport block with one or more of a defined value, in response to a data field size of the given RLC PDU being zero. The components 4302-4304 may include a means for maximizing a number of RLC PDUs multiplexed into a transport block, and a means for implementing MAC padding instead of multiplexing a given RLC PDU into the transport block, in response to a data field size of the given RLC PDU being zero. Said means may be or may include at least one control processor (e.g., the controller/processor 340 of FIG. 3) operating an algorithm. The algorithm may include using the same segmentation protocol across a group of network entities participating in a broadcast service. The algorithm may include verifying that the number of RLC PDUs multiplexed from the given logical channel has been maximized. The algorithm may include verifying that the data field size of the given RLC PDU is zero, and then implementing MAC padding. For the sake of conciseness, the rest of the details regarding apparatus 4300 are not further elaborated on; however, it is to be understood that the remaining features and aspects of the apparatus 4300 are substantially similar to those described above with respect to the apparatus 1800 of FIG. 18.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or non-transitory wireless technologies, then the coaxial cable, fiber optic cable, twisted pair, DSL, or the non-transitory wireless technologies are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for synchronized radio link control (RLC) operable by a network entity, comprising:
generating an RLC protocol data unit (PDU) according to a segmentation protocol for maximizing RLC PDU size while allowing the RLC PDU to fit into a defined media access control (MAC) transport block, the RLC PDU comprising at least one RLC service data unit (SDU) or RLC SDU segment;
determining a PDU data size for each given RLC SDU; and
in response to a SDU data size for the given RLC SDU exceeding a defined size limit, (a) attaching a given RLC SDU to the RLC PDU and (b) delivering the RLC PDU to a lower layer.

2. The method of claim 1, further comprising synchronizing the protocol across the network entities participating in the broadcast service.

3. The method of claim 1, further comprising determining that the network entity is participating in the broadcast service.

4. The method of claim 1, wherein the defined size limit comprises 2047 bytes.

5. The method of claim 1, wherein the network entity comprises an evolved Node B (eNB).

6. An apparatus, comprising:
at least one processor configured to: generate a radio link control (RLC) protocol data unit (PDU) according to a segmentation protocol for maximizing RLC PDU size while allowing the RLC PDU to fit into a defined media access control (MAC) transport block, the RLC PDU comprising at least one RLC service data unit (SDU) or RLC SDU segment; determine a PDU data size for each given RLC SDU; and (a) attach a given RLC SDU to the RLC PDU and (b) deliver the RLC PDU to a lower layer, in response to a SDU data size for the given RLC SDU exceeding a defined size limit; and
a memory coupled to the at least one processor for storing data.

7. The apparatus of claim 6, wherein the at least one processor is further configured to synchronize the protocol across the network entities participating in the broadcast service.

8. The apparatus of claim 6, wherein the apparatus comprises an evolved Node B (eNB).

9. An apparatus, comprising:
means for generating a radio link control (RLC) protocol data unit (PDU) according to a segmentation protocol for maximizing RLC PDU size while allowing the RLC PDU to fit into a defined media access control (MAC) transport block, the RLC PDU comprising at least one RLC service data unit (SDU) or RLC SDU segment;
means for determining a PDU data size for each given RLC SDU; and
means for (a) attaching a given RLC SDU to the RLC PDU and (b) delivering the RLC PDU to a lower layer, in response to a SDU data size for the given RLC SDU exceeding a defined size limit.

10. The apparatus of claim 9, further comprising means for synchronizing the protocol across the network entities participating in the broadcast service.

11. A computer program product, comprising:
a computer-readable medium comprising code for causing a computer to:
generate a radio link control (RLC) protocol data unit (PDU) according to a segmentation protocol for maximizing RLC PDU size while allowing the RLC PDU to fit into a defined media access control (MAC) transport block, the RLC PDU comprising at least one RLC service data unit (SDU) or RLC SDU segment;
determine a PDU data size for each given RLC SDU; and
(a) attach a given RLC SDU to the RLC PDU and (b) deliver the RLC PDU to a lower layer, in response to a SDU data size for the given RLC SDU exceeding a defined size limit.

12. The computer program product of claim 11, wherein the computer-readable medium further comprises code for causing the computer to synchronize the protocol across the network entities participating in the broadcast service.

13. A method for synchronized media access control (MAC) operation operable by a network entity, comprising:
determining that the network entity is participating in a broadcast service; and
generating a MAC protocol data unit (PDU) according to a segmentation protocol for maximizing RLC PDU size across to maximize a number of RLC PDUs multiplexed from a given logical channel, the protocol being synchronized across a group of network entities participating in the broadcast service.

14. The method of claim 13, further comprising synchronizing the protocol across the network entities participating in the broadcast service.

15. The method of claim 13, wherein the network entity comprises an evolved Node B (eNB).

16. An apparatus, comprising:
at least one processor configured to: determine that the network entity is participating in a broadcast service; and generate a media access control (MAC) protocol data unit (PDU) according to a segmentation protocol for maximizing RLC PDU size across to maximize a number of RLC PDUs multiplexed from a given logical channel, the protocol being synchronized across a group of network entities participating in the broadcast service; and
a memory coupled to the at least one processor for storing data.

17. The method of claim 16, wherein the apparatus entity comprises an evolved Node B (eNB).

18. An apparatus, comprising:
means for determining that the apparatus is participating in a broadcast service; and
means for generating a media access control (MAC) protocol data unit (PDU) according to a segmentation protocol for maximizing RLC PDU size across to maximize a number of RLC PDUs multiplexed from a given logical channel, the protocol being synchronized across a group of network entities participating in the broadcast service.

19. A computer program product, comprising:
a computer-readable medium comprising code for causing a computer to:
determine that the computer is participating in a broadcast service; and
generate a media access control (MAC) protocol data unit (PDU) according to a segmentation protocol for maximizing RLC PDU size across to maximize a number of RLC PDUs multiplexed from a given logical channel, the protocol being synchronized across a group of network entities participating in the broadcast service.

20. A method for synchronized media access control (MAC) operation operable by a network entity, comprising:
maximizing a number of radio link control (RLC) protocol data units (PDUs) multiplexed into a transport block; and
in response to a data field size of a given RLC PDU being zero, padding the remaining portion of the transport block with one or more of a defined value.

21. The method of claim 20, wherein padding comprises padding the remaining portion of the transport block with zeroes.

22. An apparatus, comprising:
at least one processor configured to: maximize a number of radio link control (RLC) protocol data units (PDUs) multiplexed into a transport block; and, in response to a data field size of a given RLC PDU being zero, pad the remaining portion of the transport block with one or more of a defined value; and
a memory coupled to the at least one processor for storing data.

23. An apparatus, comprising:
means for maximizing a number of radio link control (RLC) protocol data units (PDUs) multiplexed into a transport block; and
means for padding the remaining portion of the transport block with one or more of a defined value, in response to a data field size of the given RLC PDU being zero.

24. A computer program product, comprising:
a computer-readable medium comprising code for causing a computer to:
maximize a number of radio link control (RLC) protocol data units (PDUs) multiplexed into a transport block; and
in response to a data field size of a given RLC PDU being zero, pad the remaining portion of the transport block with one or more of a defined value.
